(19) United States
(12) Patent Application Publication
(10) Pub. No.: US 2012/0212580 A1
(43) Pub. Date: Aug. 23, 2012

(54) COMPUTER-READABLE STORAGE MEDIUM HAVING DISPLAY CONTROL PROGRAM STORED THEREIN, DISPLAY CONTROL APPARATUS, DISPLAY CONTROL SYSTEM, AND DISPLAY CONTROL METHOD

(75) Inventors: Hiromasa SHIKATA, Kyoto (JP); Shiro Mouri, Kyoto (JP); Shinji Okane, Kyoto (JP)

(73) Assignee: NINTENDO CO., LTD., Kyoto (JP)

(21) Appl. No.: 13/095,259

(22) Filed: Apr. 27, 2011

(30) Foreign Application Priority Data
Feb. 18, 2011 (JP) 2011-033913

(51) Int. Cl. H04N 13/02

(52) U.S. Cl. 348/46; 348/E13.074

(57) ABSTRACT

A display control apparatus displays, by a virtual stereo camera taking an image of a virtual three-dimensional space in which a player object is positioned, a stereoscopically viewable image of the virtual three-dimensional space. At this time, when an object distance represents a distance from a point of view position of the virtual stereo camera to the player object, and a stereoscopic view reference distance represents a distance from the point of view position of the virtual stereo camera to a reference plane corresponding to a position at which a parallax is not generated when the image of the virtual three-dimensional space is taken by the virtual stereo camera, a camera parameter is set based on a stereoscopic view ratio which is a ratio of the stereoscopic view reference distance to the object distance, The stereoscopically viewable image is generated based on the camera parameter.

### CROSS REFERENCE TO RELATED APPLICATION

The disclosure of Japanese Patent Application No. 2011-33913, filed on Feb. 18, 2011, is incorporated herein by reference.

### BACKGROUND OF THE INVENTION

1. Field of the Invention

The present invention relates to a computer-readable storage medium having a display control program stored therein, a display control apparatus, a display control system, and a display control method, and more particularly to a computer-readable storage medium having stored therein a display control program executed by a computer of a display control apparatus for performing a stereoscopically viewable display, a display control apparatus, a display control system, and a display control method.

2. Description of the Background Art

In recent years, various devices for performing stereoscopically viewable display have been suggested. These devices enable stereoscopic effect to be artificially produced by causing a user to simultaneously view an image for a left eye with a user's left eye, and an image for a right eye with a user's right eye (for example, see Japanese Laid-Open Patent Publication No. 2004-007396).

The device described in Japanese Laid-Open Patent Publication No. 2004-007396 has a function of adjusting, according to an operation performed by a user, the stereoscopic effect for an object to be displayed in a stereoscopically viewable manner. Specifically, a plurality of images of the same object each of which includes an image for a left eye and an image for a right eye that have parallax therebetween are simultaneously or sequentially displayed, and the plurality of images each represent different parallax. In response thereto, a user makes an input so as to indicate whether a range represented by sense of distance of each of the plurality of images of the same object is “proper”. Thus, a proper parallax which is allowable to the user is identified, and, based on the proper parallax, a process is performed on the stereoscopic image to be displayed in the stereoscopically viewable manner.

In the device described in Japanese Laid-Open Patent Publication No. 2004-007396, when an object positioned in a virtual three-dimensional space is rendered, the stereoscopic effect for an object which is to be displayed in the stereoscopically viewable manner is adjusted based on the operation performed by the user, as described above. Thus, since the conventional devices for performing the stereoscopically viewable display perform a process of adjusting the stereoscopic effect for an object based on an input from the outside, appropriate effect for representing reality according to state of the object in the virtual three-dimensional space cannot always be realized in a natural manner.

### SUMMARY OF THE INVENTION

Therefore, an object of the present invention is to provide a computer-readable storage medium having stored therein a display control program, a display control apparatus, a display control system, and a display control method, which are capable of naturally realizing appropriate effect for representing reality according to state of an object in a virtual three-dimensional space.

A computer-readable storage medium having stored therein a display control program according to the present invention is a computer-readable storage medium having stored therein a display control program executed by a computer of a display control apparatus for taking, by using a virtual stereo camera, an image of a virtual three-dimensional space in which a predetermined object is positioned, and for causing a display device to perform a stereoscopically viewable display of the image of the virtual three-dimensional space. The display control program causes the computer to function as: stereoscopic view ratio setting means; camera parameter setting means; image generation means; and display control means. The stereoscopic view ratio setting means sets a stereoscopic view ratio which is a ratio of a stereoscopic view reference distance to an object distance. The object distance represents a distance from a point of view position of the virtual stereo camera to the predetermined object. The stereoscopic view reference distance represents a distance from the point of view position of the virtual stereo camera to a reference plane corresponding to a position at which a parallax is not generated when the image of the virtual three-dimensional space is taken by the virtual stereo camera. The camera parameter setting means sets, based on the stereoscopic view ratio having been set, a camera parameter which is a parameter associated with the virtual stereo camera. The image generation means generates, based on the camera parameter set by the camera parameter setting means, a stereoscopically viewable image which represents the virtual three-dimensional space the image of which is taken by the virtual stereo camera. The display control means causes the display device to display the stereoscopically viewable image generated by the image generation means.

In this configuration, the camera parameter is set based on the stereoscopic view ratio. Namely, the camera parameter is set based on a ratio between two distances representing state in the virtual three-dimensional space. Thus, appropriate effect for representing reality according to the state of the object in the virtual three-dimensional space can be naturally realized.

The display control program may cause the computer to further function as object distance change means for changing the object distance. In this case, the stereoscopic view ratio setting means sets the stereoscopic view ratio based on the object distance changed by the object distance change means.

In this configuration, even when the predetermined object or the virtual stereo camera is moved, and the object distance is changed, appropriate effect for representing reality according to the state of the object in the virtual three-dimensional space can be naturally realized.

The stereoscopic view ratio setting means may set the stereoscopic view ratio according to an object parameter which is a parameter associated with the predetermined object. In this case, the camera parameter setting means preferably sets the camera parameter in a state where the stereoscopic view ratio is fixed.

When the stereoscopic view ratio is constant, the stereoscopic effect for the predetermined object is not changed. On the other hand, when the stereoscopic view ratio is changed, the stereoscopic effect for the predetermined object is changed. In the configuration described above, as long as the object parameter is not changed, the stereoscopic view ratio which is set by the stereoscopic view ratio setting means is maintained so as to indicate a constant value. Therefore, deterioration in effect for representing reality according to state of the predetermined object can be effectively prevented. Examples of the object parameter include: a parameter representing a speed of the predetermined object; a parameter representing an acceleration of the predetermined object; a parameter representing the size of the predetermined object; and a parameter representing the thickness of the predetermined object.

The camera parameter setting means may include determination means and ratio change means. The determination means determines whether a state of the predetermined object is subjected to a predetermined change according to change of the object parameter. The ratio change means changes the stereoscopic view ratio when the determination means determines that the state of the predetermined object is subjected to the predetermined change.

In this configuration, when the change of the object parameter changes the state of the predetermined object, the stereoscopic view ratio is changed from a value for the state having not been changed, to converge with another value according to the change of the state. Thus, the stereoscopic view ratio is exceptionally changed when the state of the predetermined object is changed. Therefore, a user can be effectively notified of the change of the state of the predetermined object, and the stereoscopic effect for the predetermined object can become appropriate for the state of the object having been changed.

The ratio change means changes the stereoscopic view ratio so as to indicate a value based on the object parameter having been changed.

In this configuration, when the value based on the object parameter having been changed is set to an appropriate value, notification can be more effectively made about the change of the state of the predetermined object as compared to a case where stereoscopic view ratio is changed to a value which is not associated with the object parameter having been changed.

The object parameter may be a parameter indicating a moving speed of the predetermined object. In this case, the determination means determines whether the moving speed of the predetermined object is outside a predetermined threshold value. The ratio change means changes the stereoscopic view ratio so as to indicate a value based on the moving speed of the predetermined object when the determination means determines that the moving speed of the predetermined object is outside the predetermined threshold value.

In this configuration, when the moving speed of the predetermined object is outside a predetermined threshold value, the stereoscopic view ratio is changed so as to indicate a value based on the moving speed. Thus, a user can be effectively notified of the change of the moving speed of the predetermined object, and the stereoscopic effect for the predetermined object can be naturally represented according to the moving speed. “Is outside a predetermined threshold value” means both “is greater than the predetermined threshold value” and “is less than the predetermined threshold value”.

The ratio change means preferably changes the stereoscopic view ratio so as to indicate a value which is greater than a predetermined reference rate when the moving speed of the predetermined object is greater than the predetermined threshold value.

In this configuration, when the moving speed of the predetermined object is greater than the predetermined threshold value, the stereoscopic view ratio has an increased value. Thus, for example, the reference plane is moved relative to the predetermined object in a direction opposite to a direction toward the virtual stereo camera. Consequently, a user can feel as if the predetermined object is closer, and effect for representing, with reality, a state in which the moving speed of the predetermined object is increased can be effectively realized.

The ratio change means preferably changes the stereoscopic view ratio so as to indicate a value which is less than a predetermined reference rate when the moving speed of the predetermined object is less than the predetermined threshold value.

In this configuration, when the moving speed of the predetermined object is less than the predetermined threshold value, the stereoscopic view ratio has a reduced value. Thus, for example, the virtual stereo camera is distanced from the predetermined object. Consequently, a user is allowed to panoramically view the predetermined object from a distant position, and the user can naturally feel that the predetermined object is slowly moving.

The object parameter may be a parameter indicating an acceleration of the predetermined object. In this case, the determination means determines whether the acceleration of the predetermined object is outside a predetermined threshold value. The ratio change means changes the stereoscopic view ratio so as to indicate a value based on the acceleration of the predetermined object when the determination means determines that the acceleration of the predetermined object is outside the predetermined threshold value.

In this configuration, when the acceleration of the predetermined object is outside the predetermined threshold value, the stereoscopic view ratio is changed so as to indicate a value based on the acceleration of the object. Thus, a user can be effectively notified of the change of the acceleration of the predetermined object, and the stereoscopic effect for the predetermined object can be naturally represented based on the acceleration. “Is outside a predetermined threshold value” means both “is greater than the predetermined threshold value” and “is less than the predetermined threshold value”.

The ratio change means preferably changes the stereoscopic view ratio so as to indicate a value which is greater than a predetermined reference rate when the acceleration of the predetermined object in an imaging direction of the virtual stereo camera is greater than a first threshold value.

In this configuration, when the acceleration of the predetermined object in the imaging direction is greater than the first threshold value, the stereoscopic view ratio has an increased value. Thus, for example, the reference plane is moved relative to the predetermined object in a direction opposite to a direction toward the virtual stereo camera. Consequently, a user can feel as if the predetermined object is closer, and effect for representing, with reality, state in which the acceleration of the predetermined object is increased can be effectively realized.

The ratio change means preferably changes the stereoscopic view ratio so as to indicate a value which is greater than a predetermined reference rate when the acceleration of the predetermined object in an imaging direction of the virtual stereo camera is less than a second threshold value.

In this configuration, when the acceleration of the predetermined object is less than the second threshold value, the stereoscopic view ratio has an increased value. Thus, for example, the reference plane is moved relative to the predetermined object in a direction opposite to a direction toward the virtual stereo camera. Consequently, a user can feel as if the predetermined object is closer, and effect for representing, with reality, state in which the acceleration of the predetermined object is reduced can be effectively realized.

The object parameter may be a parameter indicating a size of the predetermined object. In this case, the determination means determines whether the size of the predetermined object is changed. The ratio change means changes the stereoscopic view ratio so as to indicate a value based on the size of the predetermined object when the determination means determines that the size of the predetermined object is changed.

In this configuration, the stereoscopic view ratio is changed so as to indicate a value based on the size of the predetermined object. Namely, the stereoscopic view ratio which is maintained as a first setting value when the predetermined object is small, is changed to a second setting value different from the first setting value when the predetermined object becomes great. Thus, a user can be effectively notified of the change of the size of the predetermined object, and the stereoscopic effect for the predetermined object can be naturally represented based on the size of the predetermined object.

The ratio change means preferably changes the stereoscopic view ratio so as to indicate a value which is greater than a predetermined reference rate when the size of the predetermined object is reduced.

In this configuration, when the predetermined object is small, the stereoscopic view ratio has an increased value. Thus, for example, the reference plane is moved relative to the predetermined object in a direction opposite to a direction toward the virtual stereo camera. Consequently, a user can feel as if the predetermined object is closer, and effect for representing, with reality, state in which reduction in size of the predetermined object enlarges the surrounding objects can be effectively realized.

The object parameter may be a parameter indicating a thickness of the predetermined object. In this case, the determination means determines whether the thickness of the predetermined object is changed. The ratio change means changes the stereoscopic view ratio so as to indicate a value based on the thickness of the predetermined object when the determination means determines that the thickness of the predetermined object is changed.

In this configuration, the stereoscopic view ratio is changed so as to indicate a value based on the thickness of the predetermined object. Namely, the stereoscopic view ratio which is maintained as a first setting value when the thickness of the predetermined object is great, is changed to a second setting value different from the first setting value when the thickness of the predetermined object is reduced. Thus, a user can be effectively notified of the change of the thickness of the predetermined object, and the stereoscopic effect for the predetermined object can be naturally represented based on the thickness of the predetermined object.

The ratio change means preferably changes the stereoscopic view ratio so as to indicate a value which is greater than a predetermined reference rate when the thickness of the predetermined object is reduced.

In this configuration, when the thickness of the predetermined object is reduced, the stereoscopic view ratio has an increased value. Thus, for example, the reference plane is moved relative to the predetermined object in a direction opposite to a direction toward the virtual stereo camera. Consequently, a user can feel as if the predetermined object is closer, and effect for representing, with reality, state in which the thickness of the predetermined object is reduced can be effectively realized.

The ratio change means may temporarily maintain the object distance as it is when the stereoscopic view ratio is changed.

In this configuration, when the stereoscopic view ratio is changed, only the stereoscopic view reference distance is changed while the object distance is temporarily maintained as it is. Therefore, a user viewing the stereoscopically viewable image can be effectively notified of the change of the state of the object due to change of the object parameter, so as to prevent the user from losing the predetermined object.

The ratio change means may change the stereoscopic view ratio so as to indicate a value which is different from a value based on the object parameter, and thereafter change the stereoscopic view ratio so as to indicate the value based on the object parameter, when the stereoscopic view ratio is changed.

In this configuration, it is visually emphasized that the change of the stereoscopic view ratio changes the object parameter, as compared to a case where the stereoscopic view ratio is simply changed. Therefore, a user can be more effectively notified of the change of the state of the object due to change of the object parameter.

The ratio change means may gradually change the stereoscopic view ratio.

In this configuration, the stereoscopic view ratio is gradually changed according to the change of the state of the predetermined object. Therefore, change of the state of the predetermined object can be naturally represented.

The virtual stereo camera includes a left eye camera for taking an image for a left eye and a right eye camera for taking an image for a right eye. In this case, the point of view position of the virtual stereo camera is any position between the left eye camera and the right eye camera.

In this configuration, a position coordinate of the point of view position of the virtual stereo camera is easily calculated based on a position coordinate of the left eye camera and a position coordinate of the right eye camera in the virtual three-dimensional space.

The point of view position of the virtual stereo camera may be a position of the middle point of a line segment connecting between the left eye camera and the right eye camera.

In this configuration, a position coordinate of the point of view position of the virtual stereo camera is easily calculated based on a position coordinate of the left eye camera and a position coordinate of the right eye camera in the virtual three-dimensional space.

The point of view position of the virtual stereo camera may be one of a position of the left eye camera and a position of the right eye camera.

In this configuration, a position coordinate of the point of view position of the virtual stereo camera is easily calculated based on a position coordinate of the left eye camera and a position coordinate of the right eye camera in the virtual three-dimensional space.

The display control program may cause the computer to further function as input reception means for receiving an input from input means operated by a user. The object parameter changes according to the input received by the input reception means.

The predetermined object is a subject object to be operated by a user. In the configuration, state (object parameter) of the subject object to be operated is changed according to an operation of the user. Therefore, change of the state of the subject object to be operated according to the operation of the user can be effectively represented.

The present invention may be implemented as a display control apparatus for taking, by using a virtual stereo camera, an image of a virtual three-dimensional space in which a predetermined object is positioned, and for causing a display device to perform a stereoscopically viewable display of the image of the virtual three-dimensional space. The display control apparatus includes: stereoscopic view ratio setting means; camera parameter setting means; image generation means; and display control means. The stereoscopic view ratio setting means sets a stereoscopic view ratio which is a ratio of a stereoscopic view reference distance to an object distance. The object distance represents a distance from a point of view position of the virtual stereo camera to the predetermined object. The stereoscopic view reference distance represents a distance from the point of view position of the virtual stereo camera to a reference plane corresponding to a position at which a parallax is not generated when the image of the virtual three-dimensional space is taken by the virtual stereo camera. The camera parameter setting means sets, based on the stereoscopic view ratio having been set, a camera parameter which is a parameter associated with the virtual stereo camera. The image generation means generates, based on the camera parameter set by the camera parameter setting means, a stereoscopically viewable image which represents the virtual three-dimensional space the image of which is taken by the virtual stereo camera. The display control means causes the display device to display the stereoscopically viewable image generated by the image generation means.

Further, the present invention may be implemented as a display control system for taking, by using a virtual stereo camera, an image of a virtual three-dimensional space in which a predetermined object is positioned, and for causing a display device to perform a stereoscopically viewable display of the image of the virtual three-dimensional space. The display control system includes: stereoscopic view ratio setting means; camera parameter setting means; image generation means; and display control means. The stereoscopic view ratio setting means sets a stereoscopic view ratio which is a ratio of a stereoscopic view reference distance to an object distance. The object distance represents a distance from a point of view position of the virtual stereo camera to the predetermined object. The stereoscopic view reference distance represents a distance from the point of view position of the virtual stereo camera to a reference plane corresponding to a position at which a parallax is not generated when the image of the virtual three-dimensional space is taken by the virtual stereo camera. The camera parameter setting means sets, based on the stereoscopic view ratio having been set, a camera parameter which is a parameter associated with the virtual stereo camera. The image generation means generates, based on the camera parameter set by the camera parameter setting means, a stereoscopically viewable image which represents the virtual three-dimensional space the image of which is taken by the virtual stereo camera. The display control means causes the display device to display the stereoscopically viewable image generated by the image generation means.

Moreover, the present invention may be implemented as a display control method for taking, by using a virtual stereo camera, an image of a virtual three-dimensional space in which a predetermined object is positioned, and for causing a display device to perform a stereoscopically viewable display of the image of the virtual three-dimensional space. In the display control method, firstly, a stereoscopic view ratio which is a ratio of a stereoscopic view reference distance to an object distance is set. The object distance represents a distance from a point of view position of the virtual stereo camera to the predetermined object. The stereoscopic view reference distance represents a distance from the point of view position of the virtual stereo camera to a reference plane corresponding to a position at which a parallax is not generated when the image of the virtual three-dimensional space is taken by the virtual stereo camera. Subsequently, a camera parameter which is a parameter associated with the virtual stereo camera is set based on the stereoscopic view ratio having been set. Subsequently, a stereoscopically viewable image which represents the virtual three-dimensional space the image of which is taken by the virtual stereo camera, is generated based on the camera parameter having been set. The stereoscopically viewable image having been generated is displayed by using the display device.

According to the present invention, a stereoscopically viewable image representing the virtual three-dimensional space the image of which is taken by the virtual stereo camera according to a camera parameter which is set based on the stereoscopic view ratio which is a ratio of the stereoscopic view reference distance to the object distance, is displayed by using the display device. At this time, the camera parameter is set based on the ratio between two distances representing the state of the virtual three-dimensional space, instead of based on data inputted from the outside. Therefore, appropriate effect for representing reality according to the state of the object in the virtual three-dimensional space can be naturally realized.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in opened state;

FIG. 2A is a left side view of the game apparatus 10 in closed state;

FIG. 2B is a front view of the game apparatus 10 in the closed state;

FIG. 2C is a right side view of the game apparatus 10 in the closed state;

FIG. 2D is a rear view of the game apparatus 10 in the closed state;

FIG. 3 is a block diagram illustrating an internal configuration of the game apparatus 10;

FIG. 4 is a diagram illustrating state in which a player object 50 is running;

FIG. 5 is a diagram illustrating state in which the player object 50 is rapidly accelerating;

FIG. 6 is a diagram illustrating state in which the player object 50 is hit by lightning, and the size of the player object 50 is reduced;

FIG. 7 is a diagram illustrating state in which a weight is dropped on the player object 50, and the thickness of the player object 50 is reduced;

FIG. 8 is a diagram schematically illustrating a virtual three-dimensional space which is obtained when a setting ratio d2/d1 is set as a reference rate;

FIG. 9 is a diagram schematically illustrating the virtual three-dimensional space which is obtained when the setting ratio d2/d1 is set as a reduced value;

FIG. 10 is a diagram schematically illustrating the virtual three-dimensional space which is obtained when the setting ratio d2/d1 is set as an increased value;

FIG. 11 shows a memory map of a main memory 32;

FIG. 12 is a flow chart illustrating an exemplary main process performed by the game apparatus 10;

FIG. 13 is a flow chart showing in detail a camera control process of step S4 shown in FIG. 12;

FIG. 14 is a diagram schematically illustrating the virtual three-dimensional space which is obtained when a stereoscopic view reference distance d2 is set as an increased value in a state where an object distance d1 is maintained as it is;

FIG. 15 is a flow chart showing in detail the camera control process of step S4 shown in FIG. 12; and

FIG. 16 is a flow chart showing in detail the camera control process of step S4 shown in FIG. 12.

### DESCRIPTION OF THE PREFERRED EMBODIMENTS

### First Embodiment

Hereinafter, a first embodiment of the present invention will be described with reference to drawings as necessary.

### Configuration of Game Apparatus 10

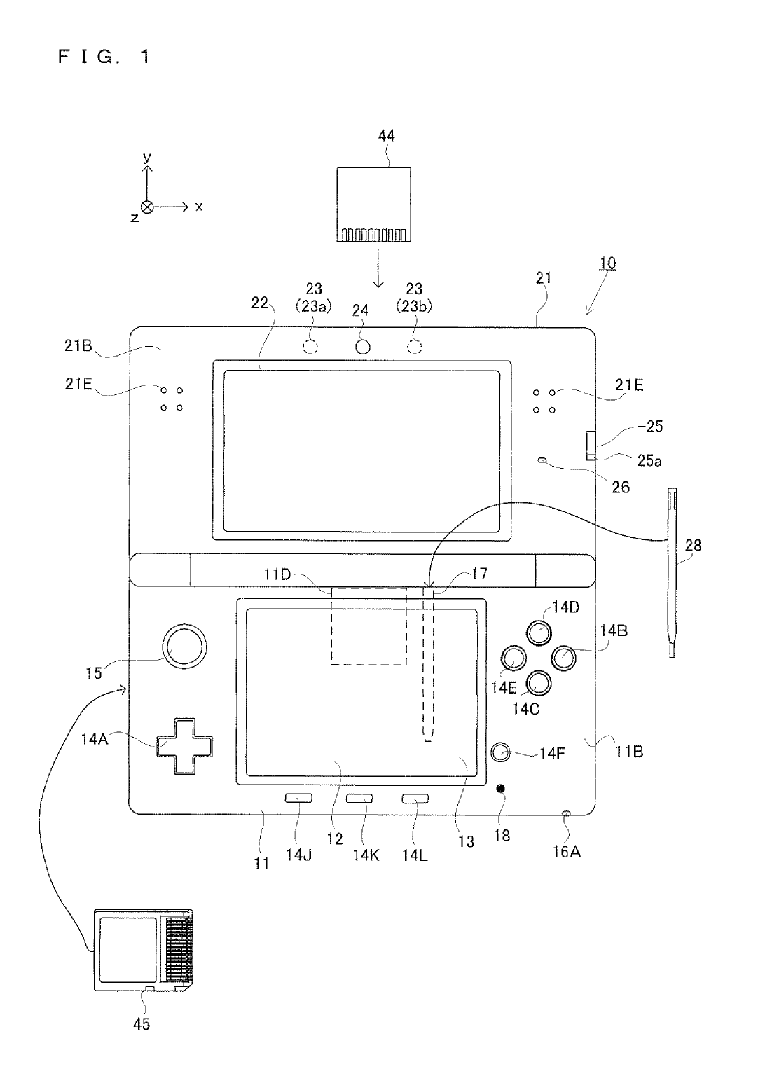

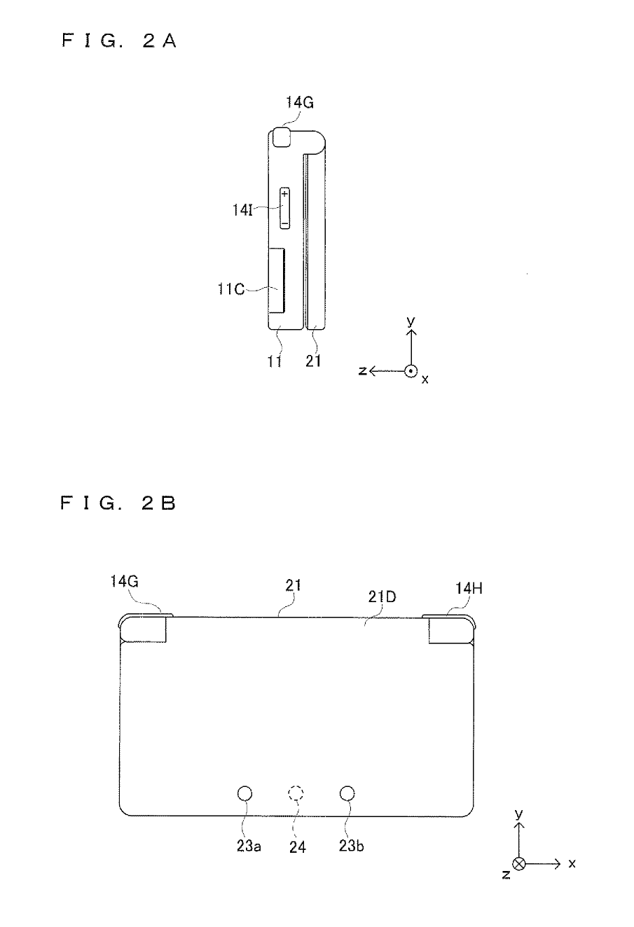

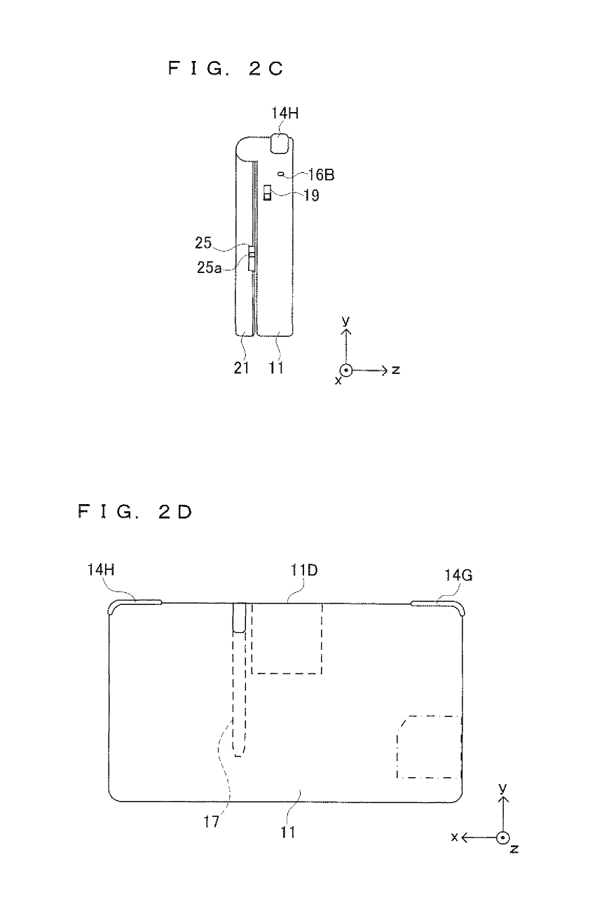

Firstly, a game apparatus 10 typifying a display control apparatus according to one embodiment of the present invention will be described. The game apparatus 10 is a hand-held game apparatus. As shown in FIG. 1, and FIGS. 2A to 2D, the game apparatus 10 includes a lower housing 11 and an upper housing 21. The lower housing 11 and the upper housing 21 are connected to each other so as to be openable and closable (foldable).

### Description of Lower Housing 11

As shown in FIG. 1, and FIGS. 2A to 2D, the lower housing 11 is provided with a lower LCD (Liquid Crystal Display) 12, a touch panel 13, operation buttons 14A to 14L, an analog stick 15, an LED 16A and an LED 16B, an insertion opening 17, and a microphone hole 18.

The touch panel 13 is mounted on the screen of the lower LCD 12. The insertion opening 17 (indicated by dashed line in FIG. 1 and FIG. 2D) is provided on the upper side surface of the lower housing 11 for accommodating a touch pen 28.

A cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11.

The analog stick 15 is a device for indicating a direction.

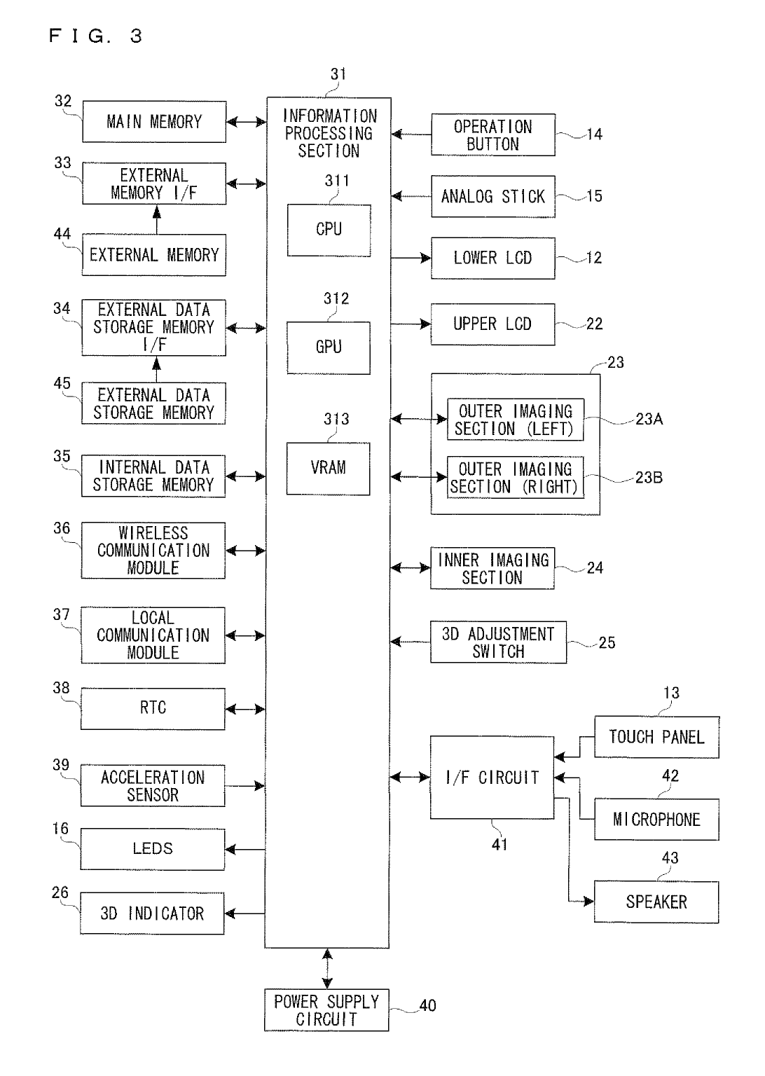

The microphone hole 18 is provided on the inner side surface of the lower housing 11. Under the microphone hole 18, a microphone 42 (see FIG. 3) is provided as a sound input device described below.

As shown in FIG. 2B and FIG. 2D, the L button 14G and the R button 14H are provided on the upper side surface of the lower housing 11. As shown in FIG. 2A, a sound volume button 141 is provided on the left side surface of the lower housing 11 for adjusting a sound volume of a speaker 43 (shown in FIG. 3) of the game apparatus 10.

As shown in FIG. 2A, a cover section 11 C is provided on the left side surface of the lower housing 11 so as to be openable and closable. Inside the cover section 11C, a connector is provided for electrically connecting between the game apparatus 10 and an external data storage memory 45.

As shown in FIG. 2D, an insertion opening 11D through which an external memory 44 is inserted is provided on the upper side surface of the lower housing 11.

As shown in FIG. 1 and FIG. 2C, a first LED 16A for notifying a user of an ON/OFF state of a power supply of the game apparatus 10 is provided on the lower side surface of the lower housing 11. A second LED 16B for notifying a user of an establishment state of a wireless communication of the game apparatus 10 is provided on the right side surface of the lower housing 11. The game apparatus 10 can make wireless communication with other devices, and a wireless switch 19 for enabling/disabling the function of the wireless communication is provided on the right side surface of the lower housing 11 (see FIG. 2C).

### Description of Upper Housing 21

As shown in FIG. 1 and FIG. 2, the upper housing 21 is provided with an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26.

The upper LCD 22 is a display device capable of displaying a stereoscopically viewable image. Specifically, the upper LCD 22 is a display device which allows a user to view a stereoscopic image with her/his naked eyes by utilizing parallax barrier. The upper LCD 22 allows a user to view the image for a left eye with her/his left eye, and the image for a right eye with her/his right eye by utilizing a parallax barrier, so that a stereoscopic image (stereoscopically viewable image) exerting a stereoscopic effect for a user can be displayed. Further, the upper LCD 22 may disable the parallax barrier. When the parallax barrier is disabled, an image can be displayed in a planar manner. Thus, the upper LCD 22 is a display device capable of switching between a stereoscopic display mode for displaying a stereoscopically viewable image and a planar display mode for displaying an image in a planar manner (for displaying a planar view image). The switching of the display mode is performed by means of, for example, the 3D adjustment switch 25 described below.

Two imaging sections (23a and 23b) provided on the outer side surface 21D of the upper housing 21 are generically referred to as the outer imaging section 23. The outer imaging section (left) 23a and the outer imaging section (right) 23b can be used as a stereo camera according to a program executed by the game apparatus 10.

The inner imaging section 24 is positioned on the inner side surface 21B of the upper housing 21, and acts as an imaging section which has an imaging direction which is the same direction as the inward normal direction of the inner side surface.

The 3D adjustment switch 25 is a slide switch, and is used for switching a display mode of the upper LCD 22 as described above. The 3D adjustment switch 25 is used for adjusting the stereoscopic effect of a stereoscopically viewable image (stereoscopic image) which is displayed on the upper LCD 22. A slider 25a of the 3D adjustment switch 25 can be slid to any position in a predetermined direction (upward/downward direction), and a display mode of the upper LCD 22 is determined according to the position of the slider 25a. Further, the viewable manner for the stereoscopic image is adjusted according to the position of the slider 25a.

The 3D indicator 26 is implemented as LEDs for indicating whether the upper LCD 22 is in the stereoscopic display mode.

Further, a speaker hole 21E is provided on the inner side surface of the upper housing 21. Sound is outputted through the speaker hole 21E from the speaker 43 described below.

### Internal Configuration of Game Apparatus 10

Next, an internal electrical configuration of the game apparatus 10 will be described with reference to FIG. 3. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, a power supply circuit 40, an interface circuit (I/F circuit) 41, and the like.

The information processing section 31 includes: a CPU (Central. Processing Unit) 311 for executing a predetermined program; a GPU (Graphics Processing Unit) 312 for performing image processing; and a VRAM (Video RAM) 313. The CPU 311 executes a program stored in a memory (for example, the external memory 44 connected to the external memory I/F 33, or the internal data storage memory 35) in the game apparatus 10, to execute a process based on the program. The program executed by the CPU 311 may be obtained from another device through communication with the other device. The GPU 312 generates an image according to an instruction from the CPU 311, and renders the image in the VRAM 313. The image rendered in the VRAM 313 is outputted to the upper LCD 22 and/or the lower LCD 12, and the image is displayed on the upper LCD 22 and/or the lower LCD 12.

The external memory I/F 33 is an interface for detachably connecting to the external memory 44. The external data storage memory I/F 34 is an interface for detachably connecting to the external data storage memory 45.

The main memory 32 is volatile storage device used as a work area and a buffer area for (the CPU 311 of) the information processing section 31.

The external memory 44 is non-volatile storage device for storing, for example, a program executed by the information processing section 31. The external memory 44 is implemented as, for example, a read-only semiconductor memory.

The external data storage memory 45 is implemented as a non-volatile readable and writable memory (for example, a NAND flash memory), and is used for storing any data.

The internal data storage memory 35 is implemented as a non-volatile readable and writable memory (for example, a NAND flash memory), and is used for storing predetermined data. For example, data and/or programs downloaded through the wireless communication module 36 by wireless communication are stored in the internal data storage memory 35.

The wireless communication module 36 has a function of connecting to a wireless LAN by using a method compliant with, for example, IEEE 802.11.b/g standard. The local communication module 37 has a function of performing wireless communication with the same type of game apparatus in a predetermined communication method (for example, a communication based on an independent protocol, or infrared communication).

The acceleration sensor 39 detects magnitudes of accelerations (linear accelerations) in the directions of the straight lines along the three axial (xyz axial) directions, respectively. The information processing section 31 can receive data (acceleration data) representing accelerations detected by the acceleration sensor 39, and detect an orientation and a motion of the game apparatus 10.

The RTC 38 counts time and outputs the counted time to the information processing section 31. The information processing section 31 calculates a current time (date) based on the time counted by the RTC 38. The power supply circuit 40 controls power to be supplied from a power supply (the rechargeable battery) of the game apparatus 10, and supplies power to each component of the game apparatus 10.

The touch panel 13, the microphone 42, and the speaker 43 are connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The information processing section 31 obtains the touch position data to recognize a position at which an input on the touch panel 13 is made.

The operation button 14 includes the operation buttons 14A to 14L described above. Operation data representing an input state of each of the operation buttons 14A to 141 is outputted from the operation button 14 to the information processing section 31, and the input state indicates whether or not each of the operation buttons 14A to 141 has been pressed.

The lower LCD 12 and the upper LCD 22 are connected to the information processing section 31. Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye, which are stored in the VRAM 313 of the information processing section 31, are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically viewable image is displayed on the screen of the upper LCD 22.

The outer imaging section 23 and the inner imaging section 24 each take an image according to an instruction from the information processing section 31, and data of the taken images are outputted to the information processing section 31.

The 3D adjustment switch 25 transmits, to the information processing section 31, an electrical signal based on the position of the slider 25a.

The information processing section 31 controls whether or not the 3D indicator 26 is to be lit up. For example, the information processing section 31 lights up the 3D indicator 26 when the upper LCD 22 is in the stereoscopic display mode.

The configuration of the hardware described above is only an exemplary configuration. The configuration of the game apparatus 10 may be modified as necessary.

### Outline of Game

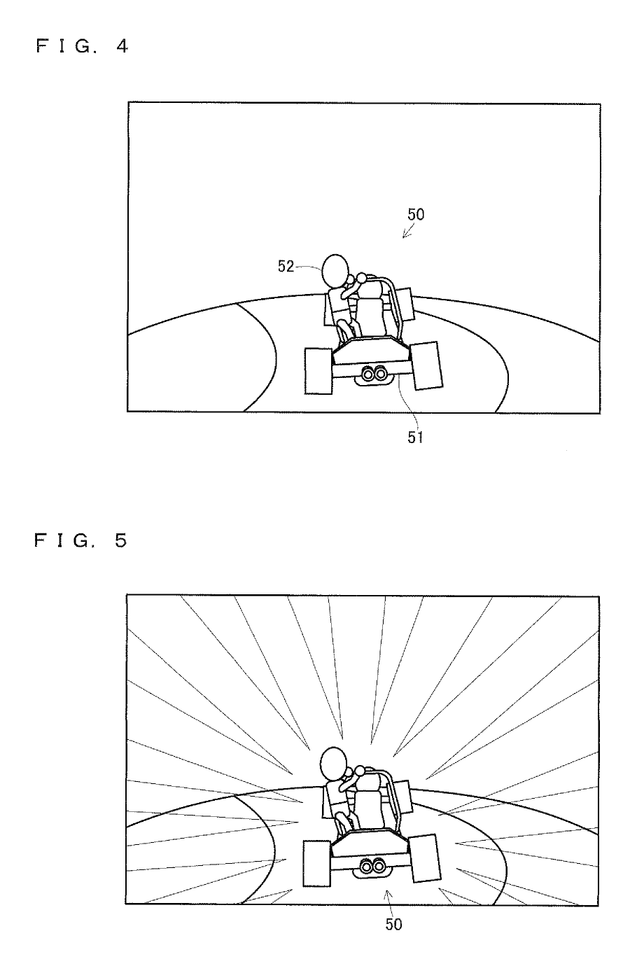

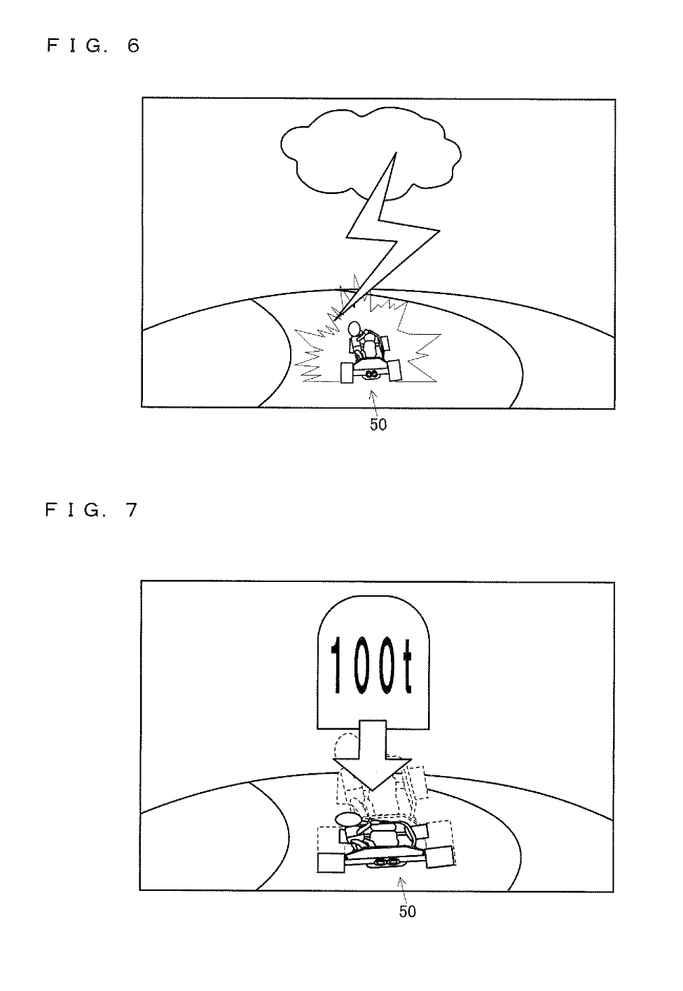

An outline of a game which is progressed by the CPU 311 of the game apparatus 10 executing a display control program will be described with reference to FIG. 4 to FIG. 7. FIG. 4 is a diagram illustrating state in which a player object 50 is running. FIG. 5 is a diagram illustrating state in which the player object 50 is rapidly accelerating. FIG. 6 is a diagram illustrating state in which the player object 50 is hit by lightning, and the size of the player object 50 is reduced. FIG. 7 is a diagram illustrating state in which a weight is dropped on the player object 50, and the thickness of the player object 50 is reduced.

The game executed in the present embodiment is a race game in which a user (player) operates the player object 50 (an example of a predetermined object) positioned in a virtual three-dimensional space (virtual game space), to compete in order of arrival. The player object 50 is a subject object to be operated by the player. The player object 50 includes: a cart 51; and a player character 52 that rides the cart 51.

Further, a player operates the cross button 14A, the button 14B, the button 14C, and the button 14E, thereby enabling control of the movement of the player object 50. When the player operates the cross-button 14A, the player object 50 can change its running direction.

When a player presses the button 14B, the player object 50 sequentially accelerates up to a normal speed, and the moving speed of the player object 50 becomes constant as the normal speed. Namely, the button 14B acts as an acceleration button in the present embodiment.

When a player presses the button 14C, the player object 50 sequentially decelerates. Namely, the button 14C acts as a brake button in the present embodiment. Also when a player presses none of the button 14B, the button 14C, and the button 14E, the player object 50 decelerates. However, when the button 14C is pressed, the player object 50 decelerates at an increased change rate as compared to when not any of the button 14B, the button 14C, and the button 14E are pressed.

When a player presses the button 14E, an item used for rapidly accelerating the player object 50 can be used. Therefore, when the button 14E is pressed, the player object 50 rapidly accelerates from a speed obtained at a point of time when the button 14E is pressed, up to a maximum speed which is higher than or equal to the normal speed described above (the acceleration is enhanced as compared to an acceleration obtained when the button 14B is pressed). Namely, the button 14E acts as a rapid acceleration button (item use button) in the present embodiment.

Assignment of the functions of the respective buttons 14 described in the present embodiment is only an example. Each action of the player object 50 described in the present embodiment may be realized by an operation on another button.

In the race game of the present embodiment, state of the player object 50 may be changed according to: an operation performed by a player; use of an item by an enemy character on another cart with which the player object 50 competes in order of arrival; change of other objects and/or the like. Namely, for example, when a player presses the button 14E, the player object 50 enters state in which the player object 50 is rapidly accelerating (see FIG. 4 and FIG. 5). Further, when a player presses the button 14C, the player character 52 puts on the brake to decelerate the player object 50. Furthermore, when the player object 50 collides against, for example, an obstacle (for example, a wall), the player object 50 rapidly decelerates (the deceleration is increased as compared to the deceleration obtained when the button 14C is pressed). Moreover, when, for example, the enemy character uses an item for causing lightning strike, the player object 50 is hit by the lightning and reduced in size (see FIG. 6), and when a predetermined time (for example, 10 seconds) elapses since the use of the item, the player object 50 is restored to an original size (see FIG. 4). In addition, a weight object (hereinafter, simply referred to as a “weight”) representing a weight which repeatedly move upward and downward at predetermined time intervals is positioned in the virtual three-dimensional space. When the player object 50 is compressed by the weight, the player object 50 is reduced in thickness (see FIG. 7). When a predetermined time (for example, 5 seconds) elapses since the compression of the player object 50 by the weight, the player object 50 is restored to an original thickness (see FIG. 4). In the game apparatus 10 according to the present embodiment, a process of controlling an object distance d1 and a stereoscopic view reference distance d2 is performed as described below in order to effectively notify a player of the change in state of the player object 50 as described above.

### Description of Stereoscopic View Ratio d2/d1

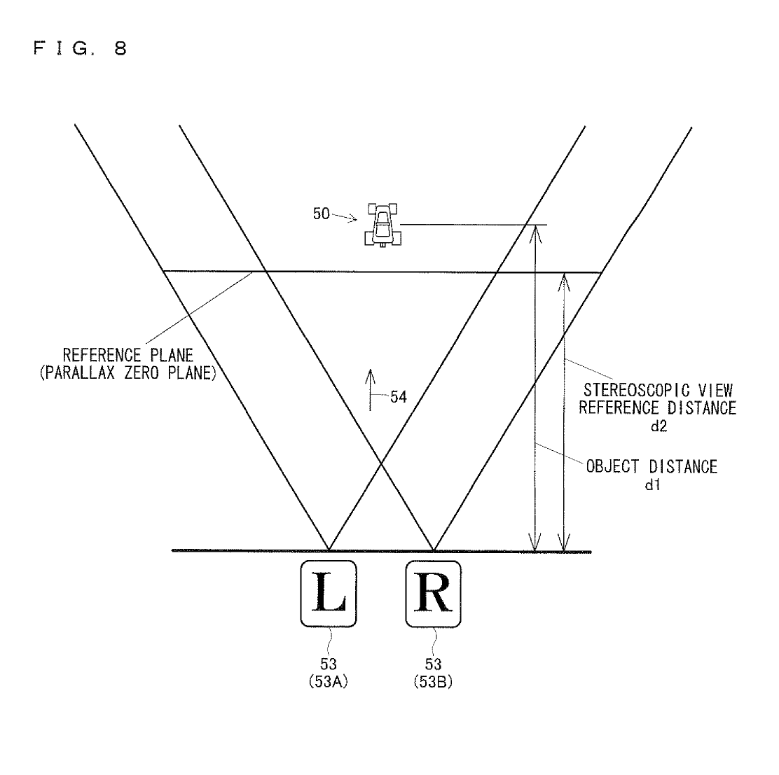

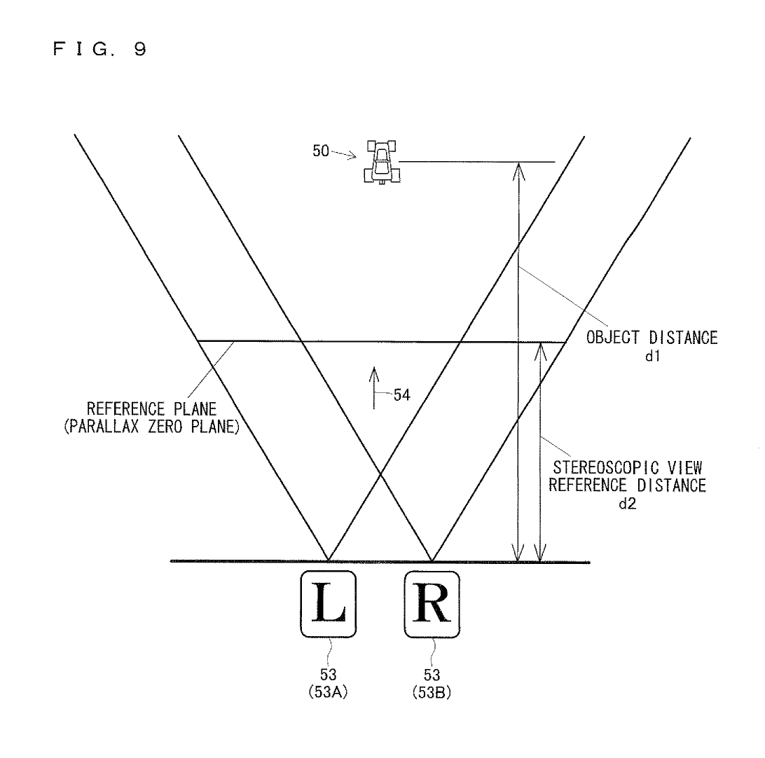

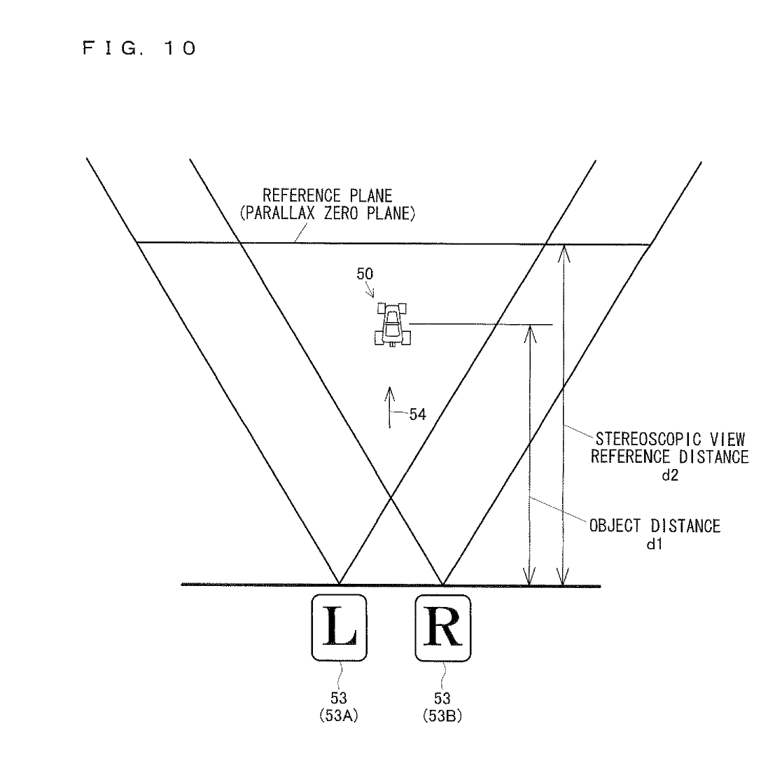

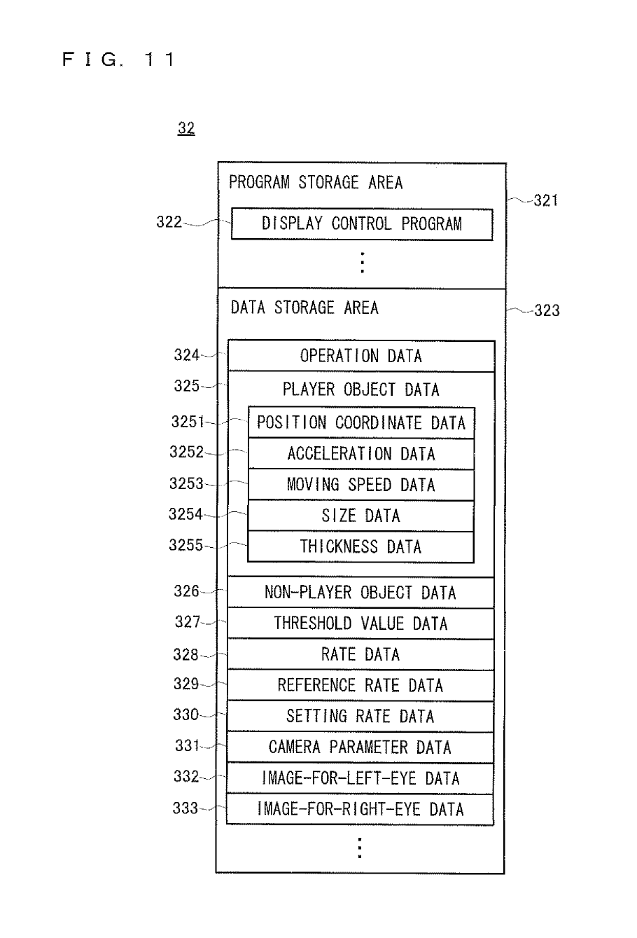

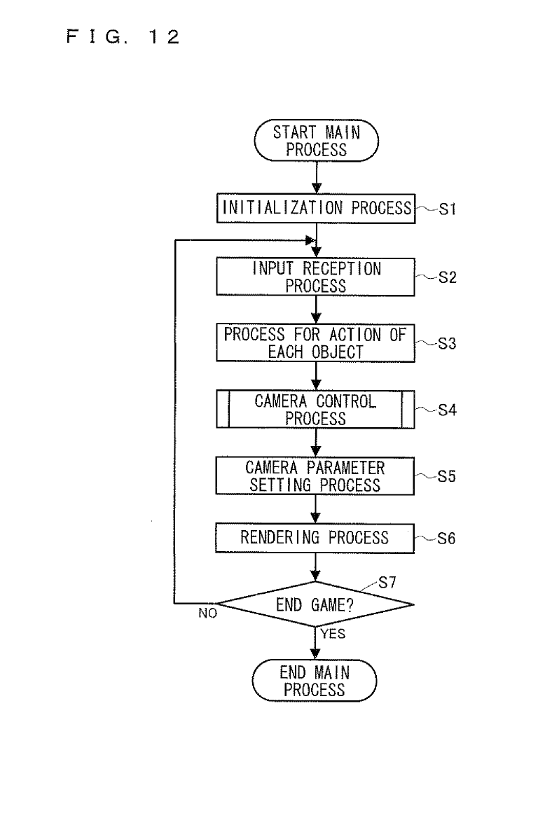

Hereinafter, a stereoscopic view ratio d2/d1 will be described with reference to FIG. 8 to FIG. 10. FIG. 8 is a diagram schematically illustrating a virtual three-dimensional space which is obtained when a setting ratio d2/d1 is set as a reference rate. FIG. 9 is a diagram schematically illustrating the virtual three-dimensional space which is obtained when the setting ratio d2/d1 is set as a reduced value. FIG. 10 is a diagram schematically illustrating the virtual three-dimensional space which is obtained when the setting ratio d2/d1 is set as an increased value.

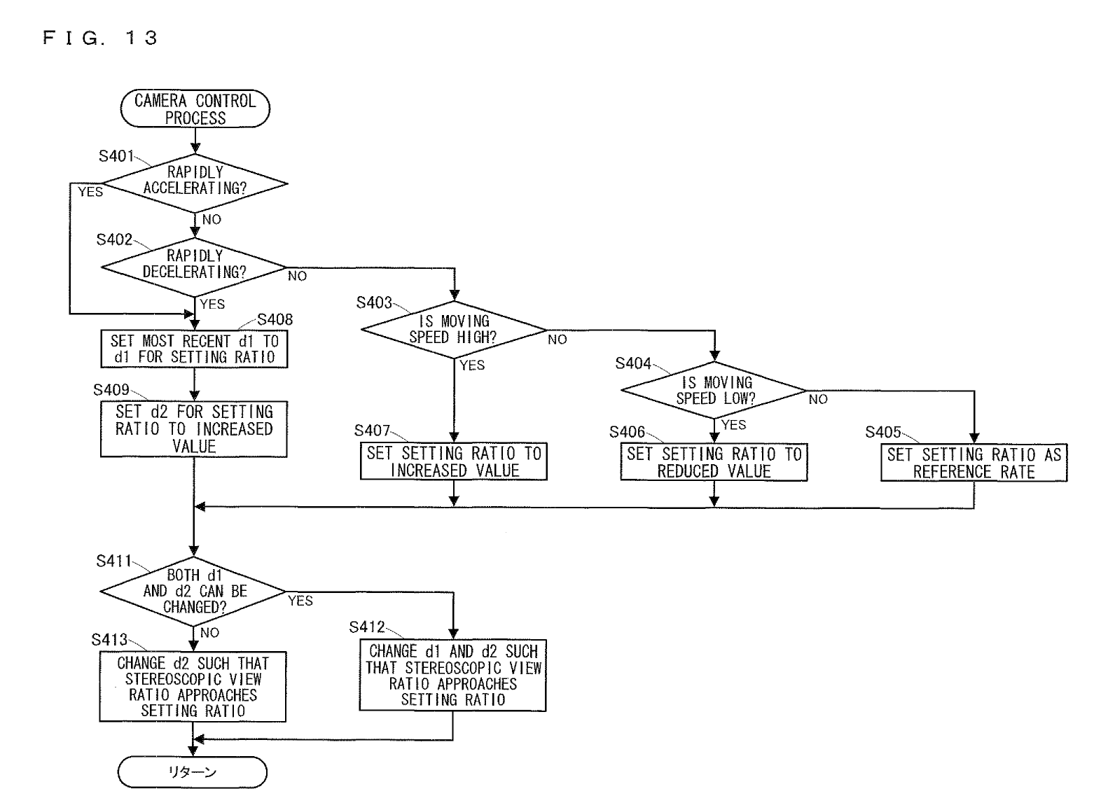

As shown in FIG. 8 to FIG. 10, a virtual stereo camera 53 and the player object 50 the image of which is taken by the virtual stereo camera 53 are positioned in the virtual three-dimensional space. The virtual stereo camera 53 includes a camera-for-left-eye 53A for taking an image for a left eye which is viewed by a player with her/his left eye, and a camera-for-right-eye 53B for taking an image for a right eye which is viewed by the player with her/his right eye. In FIG. 8 to FIG. 10, two straight lines extending from each of the camera-for-left-eye 53A and the camera-for-right-eye 53B define an imaging range (angle of view) of each of the virtual cameras 53A and 53B. In the game apparatus 10, when the information processing section 31 executes the display control program 322 (see FIG. 11), an image of the virtual three-dimensional space is taken by the virtual stereo camera 53 (the camera-for-left-eye 53A and the camera-for-right-eye 53B) so as to generate the image for the left eye and the image for the right eye, and the image for the left eye and the image for the right eye are stereoscopically displayed as a stereoscopically viewable image on the upper LCD 22.

As shown in FIG. 8 to FIG. 10, a reference plane (parallax zero plane) is defined for the virtual three-dimensional space the image of which is taken by the virtual stereo camera 53 as described above. The reference plane is defined at a position at which no parallax is generated when the image of the virtual three-dimensional space is taken by the virtual stereo camera 53. The game apparatus 10 performs control so as to position the reference plane on the surface of the screen of the upper LCD 22. Therefore, an object positioned on the reference plane is reproduced as if the object exists on the surface of the screen of the upper LCD 22. An object positioned in front of the reference plane (on the virtual stereo camera 53 side from the reference plane) is reproduced as if the object exists at a position in front of the screen of the upper LCD 22, and an object positioned on the far side from the reference plane is reproduced as if the object exists on the far side from the screen of the upper LCD 22.

Viewability (stereoscopic effect) of the stereoscopically viewable image displayed on the upper LCD 22 is changed according to a positional relationship between the object and the reference plane. Viewed from opposite point of view, even when camera parameters such as a distance between the camera-for-left-eye 53A and the camera-for-right-eye 53B, and an angle of view (an angle between two straight lines) of each of the camera-for-left-eye 53A and the camera-for-right-eye 53B, and/or a distance from the virtual stereo camera 53 to the object are changed, if the stereoscopic view ratio d2/d1 is maintained as a constant value, the stereoscopic effect for the object is maintained. Namely, if the stereoscopic view ratio d2/d1 is not changed. a player feels that the stereoscopic effect for the object is unchanged. The object distance d1 is a distance to the player object 50 from a point of view position of the virtual stereo camera 53 (the middle point between the point of view position of the camera-for-left-eye 53A and the point of view position of the camera-for-right-eye 53B in the present embodiment) in an imaging direction 54 of the virtual stereo camera 53. The stereoscopic view reference distance d2 is a distance to the reference plane from the point of view position of the virtual stereo camera 53 in the imaging direction 54 of the virtual stereo camera 53. The point of view position of the virtual stereo camera 53 is not limited to the middle point between the point of view position of the camera-for-left-eye 53A and the point of view position of the camera-for-right-eye 53B. The point of view position of the virtual stereo camera 53 may be any position between the point of view position of the camera-for-left-eye 53A and the point of view position of the camera-for-right-eye 53B.

In the game apparatus 10 according to the present embodiment, in order to naturally represent appropriate reality according to state of the player object 50, the stereoscopic view ratio d2/d1 is controlled based on the state of the player object 50 when the camera parameters of the virtual stereo camera 53 are set.

As illustrated in FIG. 8, when the stereoscopic view ratio d2/d1 is set to a reference rate (for example, “0.9”), the player object 50 is reproduced on the slightly far side in the screen of the upper LCD 22. Namely, the player object 50 seems slightly retracted from the screen of the upper LCD 22.

Further, as illustrated in FIG. 9, when the stereoscopic view ratio d2/d1 is set to a reduced value (for example, “0.6”), since the stereoscopic view reference distance d2 is smaller than the object distance d1, the player object 50 is reproduced on the far side in the screen of the upper LCD 22 as compared to a case where the stereoscopic view ratio d2/d1 is set to the reference rate. Therefore, a player can panoramically view the player object 50 from a slightly distant (far) position.

As illustrated in FIG. 10, when the stereoscopic view ratio d2/d1 is set to an increased value (for example, “1.2”), since the stereoscopic view reference distance d2 is greater than the object distance d1, the player object 50 is reproduced as if the player object 50 exists in front of the screen of the upper LCD 22. Therefore, a player can view the player object 50 at a short distance with reality as if the player object 50 is located in front of her/his eyes. As described below in detail, in the game apparatus 10 according to the present embodiment, the stereoscopic view ratio d2/d1 is controlled based on the state of the player object 50 (for example, a moving speed, an acceleration, a size, and a thickness of the player object 50).

### Memory Map

Hereinafter, data to be stored in the main memory 32 will be described with reference to FIG. 11. FIG. 11 shows a memory map of the main memory 32. As illustrated in FIG. 11, the main memory 32 includes a program storage area 321 and a data storage area 323. In the program storage area 321, programs executed by the CPU 311 are stored. In the data storage area 323, various data are stored which are necessary for a process for taking an image of the virtual three-dimensional space by the virtual stereo camera 53, and displaying the image on the upper LCD 22. The programs in the program storage area 321 and a portion of data in the data storage area 323 are previously stored in the external memory 44, and are loaded into the main memory 32 from the external memory 44 for taking the image of the virtual three-dimensional space by the virtual stereo camera 53.

In the program storage area 321, a display control program 322 and the like are stored. The display control program 322 is a program for causing the information processing section 31 to execute a series of process steps shown in flow charts of FIGS. 12, 13, 15, and 16.

In the data storage area 323, operation data 324, player object data 325, non-player object data 326, threshold value data 327, rate data 328, reference rate data 329, setting rate data 330, camera parameter data 331, image-for-left-eye data 332, image-for-right-eye data 333, and the like are stored.

The operation data 324 represents an operation performed by a user on any one of the operation buttons 14A to 14E and 14G to 14H, the analog stick 15, and the touch panel 13.

The player object data 325 represents object parameters associated with the player object 50. The player object data 325 is data representing an orientation, a shape (polygon shape), and a color (texture) of the player object 50. Further, the player object data 325 includes position coordinate data 3251, acceleration data 3252, moving speed data 3253, size data 3254, thickness data 3255, and the like. The position coordinate data 3251 represents a position coordinate of the player object 50 in the virtual three-dimensional space. The acceleration data 3252 represents a parameter indicating an acceleration or a deceleration of the player object 50. In other words, the acceleration data 3252 represents a parameter indicating an acceleration generated in the player object 50 when the player object 50 rapidly accelerates or rapidly decelerates. The acceleration data 3252 represents an acceleration of the player object 50 when the player object 50 is rapidly accelerating, whereas the acceleration data 3252 represents a deceleration of the player object 50 when the player object 50 is rapidly decelerating. The moving speed data 3253 represents a parameter indicating a moving speed of the player object 50. The size data 3254 represents a parameter indicating a size of the player object 50. The thickness data 3255 represents a parameter indicating a thickness of the player object 50.

The non-player object data 326 represents a position, an orientation, a shape (polygon shape), a color (texture), and the like of a non-player object in the virtual three-dimensional space. The non-player object represents: another cart which competes with the player object 50 in order of arrival; a topography object; a background object; and the like.

The threshold value data 327 represents threshold values used for various determination process steps. Specifically, the threshold value data 327 represents: a threshold value for determining whether the player object 50 rapidly accelerates by the button 14E being pressed; a threshold value for determining whether the player object 50 rapidly decelerates due to, for example, collision against an obstacle; a threshold value for determining whether the moving speed of the player object 50 is changed; and the like.

The rate data 328 represents the object distance d1 most recently set, the stereoscopic view reference distance d2 most recently set, and the stereoscopic view ratio d2/d1 which has been most recently calculated based on the object distance d1 and the stereoscopic view reference distance d2. The reference rate data 329 represents the reference rate of the stereoscopic view ratio d2/d1 which is set when the state of the player object 50 remains unchanged from a normal state.

The setting rate data 330 represents an optimum setting ratio of the stereoscopic view ratio d2/d1 for the state of the player object 50. As will be described in detail below, when the state of the player object 50 remains unchanged, the setting ratio represented by the setting rate data 330 is set to the reference rate (for example, “0.9”) represented by the reference rate data 329. Thus, when the setting rate data 330 is set to the reference rate, at least one of the object distance d1 and the stereoscopic view reference distance d2 is controlled such that the stereoscopic view ratio d2/d1 represented by the rate data 328 is set so as to be maintained as the reference rate represented by the setting rate data 330. On the other hand, when the state of the player object 50 is changed, the setting ratio represented by the setting rate data 330 is set to a reduced value (for example, “0.6”), or an increased value (for example, “1.2”) according to the changed state of the player object 50. When the setting rate data 330 has been thus set, at least one of the object distance d1 and the stereoscopic view reference distance d2 is controlled such that the stereoscopic view ratio d2/d1 represented by the rate data 328 gradually approaches and converges with a value of the setting ratio which is represented, according to the changed state of player object 50, by the setting rate data 330.

The reduced value and the increased value which are set as the setting ratio are preset similarly to the reference rate represented by the reference rate data 329. Further, data representing the reduced value and the increased value is stored in the data storage area 323, which is not shown, similarly to the reference rate data 329. The reduced value or the increased value is set as the setting ratio represented by the setting rate data 330 as necessary. However, the increased value and the reduced value of the setting ratio may not necessarily be stored in the data storage area 323 in advance. For example, the increased value and the reduced value of the setting ratio may be calculated in calculation process based on the display control program 322 using the reference rate data 329 each time the setting ratio is to be set.

Further, as described in detail below, the stereoscopic view ratio d2/d1 is changed, in some cases, such that, in the stereoscopic view ratio d2/d1, the object distance d1 remains unchanged while only the stereoscopic view reference distance d2 is changed. In this case, the CPU 311 stores, as the setting rate data 330, data representing the object distance d1, and data representing the stereoscopic view reference distance d2, in addition to data representing a value of the setting ratio d2/d1, in the data storage area 323. At this time, the CPU 311 sets the object distance d1 which is represented as the most recent object distance by the rate data 328, as the object distance d1 represented by the setting rate data 330, and sets the stereoscopic view reference distance d2 represented by the setting rate data 330, to, for example, a predetermined increased value. When such a setting is performed, the object distance d1 represented by the rate data 328 and the object distance d1 represented by the setting rate data 330 have the same value. Therefore, the CPU 311 changes the stereoscopic view reference distance d2 such that the stereoscopic view reference distance d2 which is represented as the most recent stereoscopic view reference distance by the rate data 328 converges with the stereoscopic view reference distance d2 represented by the setting rate data 330.

The camera parameter data 331 represents camera parameters such as a point of view position of each of the virtual cameras, that is, each of the camera-for-left-eye 53A and the camera-for-right-eye 53B, in the virtual three-dimensional space, a distance between both of the virtual cameras, an imaging direction, and an angle of view of each virtual camera. The camera parameter data 331 is set based on the stereoscopic view ratio d2/d1 represented by the rate data 328

The image-for-left-eye data 332 and the image-for-right-eye data 333 are data of an image for a left eye and an image for a right eye, respectively, which are taken by the virtual stereo camera 53, and are outputted to the upper LCD 22 each time the images are taken.

Data such as image data taken by the outer imaging section 23 or the inner imaging section 24 which is a real camera is stored in the data storage area 323, which is not shown. Such data is not directly related to the present invention, and the detailed description thereof is not given in the present embodiment.

### Description of Main Process

Next, a main process performed by the game apparatus 10 will be described with reference to FIG. 12. FIG. 12 is a flow chart showing an exemplary main process performed by the game apparatus 10. Firstly, the CPU 311 initializes data used in the following process steps (step S1). Specifically, the CPU 311 initializes various variables, flags, and the like which are stored in the data storage area 323, and are used in the following process steps. The CPU 311 is then operable to position, in the virtual three-dimensional space, the player object 50, and non-player objects such as a cart ridden by an enemy character and a topography object. Specifically, the CPU 311 stores, in the data storage area 323, data representing an initial position at which the virtual stereo camera 53 is to be located at the start of the game, and data representing initial states of various objects.

Subsequently, the virtual three-dimensional space is constructed, and a stereoscopically viewable image taken by the virtual stereo camera 53 is displayed on the upper LCD 22. Specifically, the CPU 311 constructs the virtual three-dimensional space, and positions, in the virtual three-dimensional space, each object according to data representing an initial state of each object. The CPU 311 causes the GPU 312 to generate a stereoscopically viewable image ((image for a left eye and image for a right eye) representing the virtual three-dimensional space viewed from the point of view of the virtual stereo camera 53, and causes the upper LCD 22 to display the stereoscopically viewable image. Subsequently, a process loop of step S2 to step S7 is repeatedly performed every one frame (for example, 1/60 seconds), thereby progressing the game.

Following step S1, the CPU 311 receives an input from input means operated by a player (step S2). Specifically, operation data representing input state of the operation buttons 14A to 14E, and 14G to 14H, the analog stick 15, and the touch panel 13 is inputted to the information processing section 31. The CPU 311 of the information processing section 31 stores the operation data as the operation data 324 in the data storage area 323. When the operation data 324 is stored anew as the most recent operation data, the operation data 324 is updated to the operation data 324 which represent the most recent operation data, as necessary. Object parameters (acceleration, moving speed, size, thickness, and the like) of the player object 50 are controlled based on, for example, the operation data 324 stored in the data storage area 323, contact between the player object 50 and another object, and action of another object.

Next, the CPU 311 performs a process for action of each object (step S3). Specifically, the CPU 311 moves the player object 50 to a position represented by the operation data 324, and moves the cart ridden by the enemy character and other non-player objects based on, for example, the display control program 322. Further, the CPU 311 is operable to change the size or the thickness of the player object 50 according to situation of the game. Thus, the player object data 325 and the non-player object data 326 stored in the data storage area 323 are updated. In the process step of step S3, the position of the player object 50 in the virtual three-dimensional space is changed, and the object distance d1 is changed according to the change of the position of the player object 50. The object distance d1 is changed according to a player's operation associated with the virtual stereo camera 53 as well as the action of the player object 50.

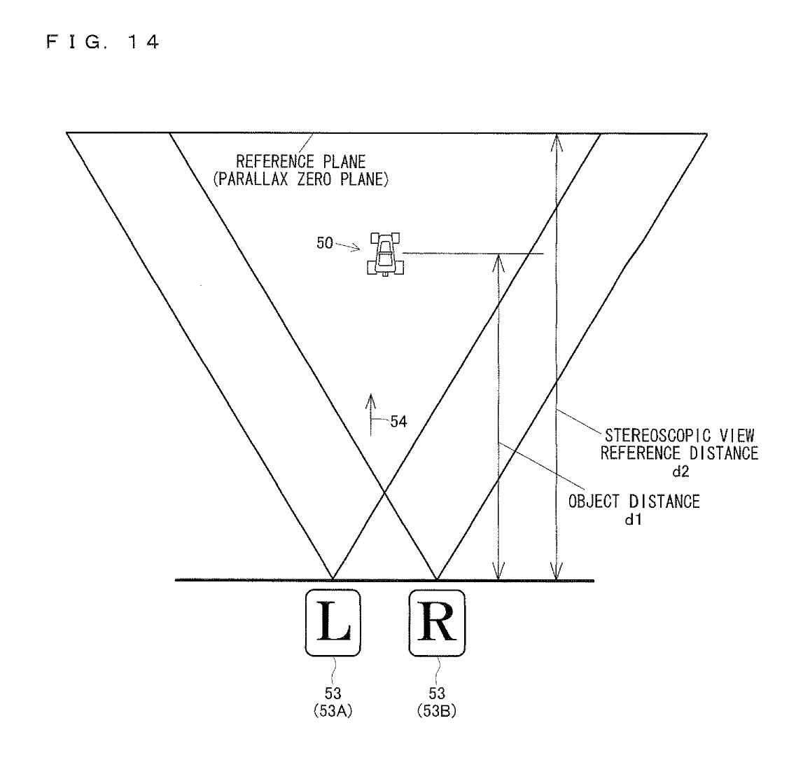

Following step S3, the CPU 311 performs a camera control process of controlling the object distance d1 and the stereoscopic view reference distance d2 such that the stereoscopic view ratio d2/d1 has a value based on the player object data 325 representing state of the player object 50 (step S4). The camera control process will be described in detail below with reference to the flow charts of FIGS. 13, 15, and 16.

Following step S4, the CPU 311 performs a camera parameter setting process of setting camera parameters of the virtual stereo camera 53 based on the process steps performed in step S2 to step S4 (step S5). Specifically, the CPU 311 sets various camera parameters such as a point of view position of each of the virtual cameras, that is, the camera-for-left-eye 53A and the camera-for-right-eye 53B, in the virtual three-dimensional space, imaging directions of each virtual camera, and an angle of view of each virtual camera, based on the player object data 325 and the non-player object data 326 which have been updated in step S2 and step S3, and on the stereoscopic view ratio d2/d1 which is represented by the rate data 328 which has been updated in step S4. The camera parameters set in step S5 is stored as the camera parameter data 331 in the data storage area 323.

When the camera parameters are set in step S5, the CPU 311 performs a rendering process (step S6). Specifically, the CPU 311 causes the GPU 312 to generate, based on the camera parameters having been set, a stereoscopically viewable image (an image for a left eye and an image for a right eye) which represents the virtual three-dimensional space the image of which is taken by the virtual stereo camera 53. The CPU 311 causes the upper LCD 22 to display the stereoscopically viewable image having been generated.

Following step S6, the CPU 311 determines whether the end of game is indicated, based on whether the power button 14F or the like is operated (step S7). When the CPU 311 determines that the end of the game is not indicated (step S7:NO), the process is returned to step S2, and process steps of step S2 and the subsequent process steps are repeated. On the other hand, when the CPU 311 determines that the end of the game is indicated (step S7:YES), a series of game process is ended.

### Description of Camera Control Process

Hereinafter, the camera control process which is performed by the information processing section 31 when an acceleration or a moving speed of the player object 50 is changed, will be described with reference to FIG. 13. FIG. 13 is a flow chart showing in detail the camera control process of step S4 shown in FIG. 12, and illustrates an exemplary camera control process which is performed when a moving speed or an acceleration of the player object 50 is changed.

For example, when a player presses the button 14B, the player object 50 sequentially accelerates up to the normal speed described above. Thereafter, in a state where the normal speed is maintained, the player object 50 moves forward (moves in the depth direction on the plane of paper in FIG. 4). Therefore, after the moving speed of the player object 50 converges with the normal speed, while the player continues to press the button 14B, an acceleration of the player object 50 in the imaging direction 54, which is represented by the acceleration data 3252, indicates “zero”. When the player presses the button 14E (rapid acceleration button) in order to cause the cart 51 to rapidly accelerate, an acceleration represented by the acceleration data 3252 indicates a value greater than a value obtained when the button 14B (acceleration button) is pressed. When, for example, the player object 50 collides against an obstacle, a deceleration (an acceleration generated in a direction opposite to a direction in which the player object 50 runs) represented by the acceleration data 3252 becomes greater than a deceleration obtained when the button 14C (brake button) is pressed.

Following step S3, the CPU 311 firstly determines whether the player object 50 is rapidly accelerating (step S401). Specifically, the CPU 311 determines whether an acceleration represented by the acceleration data 3252 (an acceleration of the player object 50 in the direction in which the player object 50 runs) is greater than or equal to the acceleration represented by the threshold value data 327. This acceleration is an acceleration generated according to the button 14E (rapid acceleration button) being pressed, and is not an acceleration generated according to the button 14B (acceleration button) being pressed. Therefore, a threshold value used for step 5401 is set as a value which is greater than a value of an acceleration generated in the player object 50 when the button 14B is pressed. When the acceleration represented by the acceleration data 3252 is greater than or equal to the acceleration represented by the threshold value data 327, it is determined that the player object 50 is rapidly accelerating. On the other hand, when the acceleration represented by the acceleration data 3252 is less than the acceleration represented by the threshold value data 327, it is determined that the player object 50 is not rapidly accelerating. As described above, the CPU 311 determines whether the acceleration of the player object 50 is greater than a first threshold value (in the present embodiment, the acceleration represented by the threshold value data 327).

When the CPU 311 determines that the player object 50 is not rapidly accelerating (step S401:NO), the CPU 311 determines whether the player object 50 is rapidly decelerating (step S402). Specifically, the CPU 311 determines whether a deceleration represented by the acceleration data 3252 (an acceleration generated in a direction opposite to a direction in which the player object 50 runs) is greater than or equal to the deceleration represented by the threshold value data 327. In this case, the rapid deceleration is a deceleration generated according to the collision of the player object 50 against an obstacle, and is not a deceleration generated according to the button 14C (brake button) being pressed. Therefore, the threshold value used for step S402 is set as a value which is greater than a value of a deceleration generated in the player object 50 when the button 14C is pressed. When the deceleration represented by the acceleration data 3252 is greater than or equal to the deceleration represented by the threshold value data 327, it is determined that the player object 50 is rapidly decelerating. On the other hand, when the deceleration represented by the acceleration data 3252 is less than the deceleration represented by the threshold value data 327, it is determined that the player object 50 is not rapidly decelerating. As described above, the CPU 311 determines whether the acceleration of the player object 50 is less than a second threshold value (in the present embodiment, the deceleration represented by the threshold value data 327).

When the CPU 311 determines that the player object 50 is not rapidly decelerating (step S402:NO), the CPU 311 determines whether the moving speed of the player object 50 is high (step S403). Specifically, the CPU 311 determines whether the moving speed of the player object 50 represented by the moving speed data 3253 is greater than a predetermined speed (a predetermined threshold value) represented by the threshold value data 327 (whether the moving speed of the player object 50 is greater than the predetermined threshold value).

When the CPU 311 determines that the moving speed of the player object 50 is not high (step S403:NO), the CPU 311 determines whether the moving speed of the player object 50 is low (step S404). Specifically, the CPU 311 determines whether the moving speed of the player object 50 represented by the moving speed data 3253 is less than a predetermined speed (a predetermined threshold value) represented by the threshold value data 327 (whether the moving speed of the player object 50 is less than the predetermined threshold value). The predetermined speed which is represented by the threshold value data 327 used for step S404 is set so as to be smaller than the predetermined speed which is represented by the threshold value data 327 used in step S403.

When the CPU 311 determines that the moving speed of the player object 50 is not low (step S404:NO), that is, when the moving speed of the player object 50 is a normal speed, the CPU 311 sets the setting ratio d2/d1 as the reference rate (step S405). Specifically, the CPU 311 updates the setting ratio d2/d1 represented by the setting rate data 330, to a value (for example, “0.9”) represented by the reference rate data 329.

FIG. 8 illustrates a relationship between the object distance d1 and the stereoscopic view reference distance d2 obtained when the setting ratio d2/d1 is set to the reference rate. The reference rate is not limited to an exemplary value indicated in the present embodiment. The reference rate may be any appropriate value which allows a player to naturally feel the player object 50 running at a normal speed. Further, as described below in detail, when the process of setting the setting rate data 330 has been performed, at least one of the object distance d1 and the stereoscopic view reference distance d2 is controlled such that the stereoscopic view ratio d2/d1 represented by the rate data 328 converges with the setting ratio d2/d1 represented by the setting rate data 330. As a result, when the state of the player object 50 remains unchanged, the stereoscopic view ratio d2/d1 is maintained as the setting ratio d2/d1, resulting in the stereoscopic effect for the player object 50 being maintained.

When the moving speed of the player object 50 is low, it is effective that at least one of control of distancing the virtual stereo camera 53 from the player object 50 (increasing the object distance d1) and control of bringing the reference plane closer to the virtual stereo camera 53 (reducing the stereoscopic view reference distance d2) is performed so as to allow a player to naturally feel the player object 50 slowly running. Namely, it is effective to set the stereoscopic view ratio d2/d1 as a reduced value. When the stereoscopic view ratio d2/d1 is set as a reduced value, the player object 50 can be panoramically viewed by a player from a distant position. In this case, a non-player object such as a road appears to be slowly flowing relative to the player object 50 in a direction opposite to a direction in which the player object 50 runs. Therefore, the player can sufficiently feel that the moving speed of the player object 50 is low.

When the CPU 311 determines that the moving speed of the player object 50 is low (step S404:YES), the CPU 311 sets the setting ratio d2/d1 as a reduced value (step S406). Specifically, the CPU 311 updates a value of the setting ratio d2/d1 represented by the setting rate data 330 to a reduced value (for example, “0.6”). FIG. 9 illustrates a relationship between the object distance d1 and the stereoscopic view reference distance d2 obtained when the setting ratio d2/d1 is set as a reduced value.

When the setting ratio d2/d1 has been thus set as a reduced value, in a state where the moving speed of the player object 50 remains low, the object distance d1 and the stereoscopic view reference distance d2 gradually change such that the stereoscopic view ratio d2/d1 which is represented as the most recent stereoscopic view ratio by the rate data 328 approaches the setting ratio d2/d1 represented by the setting rate data 330. As a result, the stereoscopic view ratio d2/d1 represented by the rate data 328 converges with the setting ratio d2/d1, and the stereoscopic view ratio d2/d1 is maintained as a reduced value. When the stereoscopic view ratio d2/d1 is maintained as a reduced value in this manner, the stereoscopic effect for the player object 50 can be maintained, so that a player can naturally feel state of the virtual three-dimensional space displayed when the moving speed of the player object 50 is low.

When the moving speed of the player object 50 is high, it is effective that at least one of control of bringing the virtual stereo camera 53 closer to the player object 50 (reducing the object distance d1) and control of distancing the reference plane from the virtual stereo camera 53 (increasing the stereoscopic view reference distance d2) is performed so as to allow a player to naturally feel the player object 50 running at a high speed. Namely, it is effective to set the stereoscopic view ratio d2/d1 as an increased value. When the stereoscopic view ratio d2/d1 is set as an increased value, a player can view the player object 50 at a short distance as if the player object 50 is located in front of her/his eyes. In this case, a non-player object such as a road appears to be flowing at a high speed relative to the player object 50 in a direction opposite to a direction in which the player object 50 runs. Therefore, the player can sufficiently feel that the moving speed of the player object 50 is high. In other words, the player can naturally feel the player object 50 moving at a high speed with reality.

When the CPU 311 determines that the moving speed of the player object 50 is high (step S403:YES), the CPU 311 sets the setting ratio d2/d1 as an increased value (step S407). Specifically, the CPU 311 updates a value of the setting ratio d2/d1 represented by the setting rate data 330 to an increased value (for example, “1.2”). FIG. 10 illustrates a relationship between the object distance d1 and the stereoscopic view reference distance d2 obtained when the setting ratio d2/d1 is set as an increased value.

When the setting ratio d2/d1 has been thus set as an increased value, in a state where the moving speed of the player object 50 remains high, the object distance d1 and the stereoscopic view reference distance d2 gradually change such that the stereoscopic view ratio d2/d1 which is represent as the most recent stereoscopic view ratio by the rate data 328 approaches the setting ratio d2/d1 represented by the setting rate data 330. As a result, the stereoscopic view ratio d2/d1 represented by the rate data 328 converges with the setting ratio d2/d1, and the stereoscopic view ratio d2/d1 is maintained as an increased value. When the stereoscopic view ratio d2/d1 is maintained as an increased value in this manner, the stereoscopic effect for the player object 50 can be maintained, so that a player can naturally feel that effect of displaying the virtual three-dimensional space when the moving speed of the player object 50 is high is represented with reality.

When both of the object distance d1 and the stereoscopic view reference distance d2 are changed at the moment the player object 50 starts rapidly accelerating or rapidly decelerating, a player may lose the player object 50 for a moment due to the change of the object distance d1. Therefore, preferably, until completion of rapid acceleration or rapid deceleration of the player object 50, the object distance d1 is maintained as it is, and only the stereoscopic view reference distance d2 is changed to represent change in the state of the player object 50.

When the CPU 311 determines that the player object 50 is rapidly accelerating (step S401:YES), or that the player object 50 is rapidly decelerating (step S402:YES), the object distance d1 having been most recently set is set as the object distance d1 for the setting ratio (step S408). Specifically, the CPU 311 updates a value of the object distance d1 represented by the setting rate data 330, to a value of the object distance d1 which is represented as the most recent object distance by the rate data 328. The CPU 311 sets, as an increased value, the stereoscopic view reference distance d2 for the setting ratio (step S409). Specifically, the CPU 311 updates a value of the stereoscopic view reference distance d2 represented by the setting rate data 330 to a predetermined increased value, based on the display control program 322.

When the process step of step S408 and the process step of step S409 are performed, the setting ratio d2/d1 is set so as to be greater than the setting ratio which is set in the process step of step S407.

A case is described where the stereoscopic view reference distance d2 for the setting ratio d2/d1 constantly remain set as an increased value while the player object 50 is rapidly accelerating or rapidly decelerating. However, the process may be advanced to step S403 while the player object 50 is rapidly accelerating or rapidly decelerating, so as to change, during the rapid acceleration or rapid deceleration, the effect obtained from controlling of the stereoscopic view ratio d2/d1.

When the CPU 311 performs the process step of step S405, step S406, step S407, or step S409, the CPU 311 determines whether both of the object distance d1 and the stereoscopic view reference distance d2 can be changed (step S411). Specifically, the CPU 311 determines whether the object distance d1 is stored as a portion of the setting rate data 330 in the data storage area 323, and whether the object distance d1 which is represented as the most recent object distance by the rate data 328 is equal to the object distance d1 represented by the setting rate data 330.

When the object distance d1 is not stored as a portion of the setting rate data 330 in the data storage area 323, the object distance d1 is not set. Therefore, it is determined that both of the object distance d1 and the stereoscopic view reference distance d2 can be changed. Namely, when the process is advanced to step S411 after the process step of step S405, step S406, or step S407 is performed, it is determined that both of the object distance d1 and the stereoscopic view reference distance d2 can be changed. When the CPU 311 determines that both of the object distance d1 and the stereoscopic view reference distance d2 can be changed (step S411:YES). the CPU 311 changes the object distance d1 and the stereoscopic view reference distance d2 based on the player object data 325 such that the stereoscopic view ratio d2/d1 which is represented as the most recent stereoscopic view ratio by the rate data 328 approaches the setting ratio d2/d1 represented by the setting rate data 330 (step S412).

In a state where the moving speed of the player object 50 gradually changes without rapidly accelerating or rapidly decelerating the player object 50, when the stereoscopic view ratio d2/d1 is rapidly changed to the setting ratio d2/d1, a stereoscopically viewable image which does not properly represent change in state of the virtual three-dimensional space may be displayed on the upper LCD 22. Therefore, in the process step of step S412, a change value of the stereoscopic view ratio d2/d1 at which the stereoscopic view ratio d2/d1 changes in step S412 in each process loop is reduced such that the stereoscopic view ratio d2/d1 is gradually changed to the setting ratio d2/d1. For example, in a state where the stereoscopic view ratio d2/d1 which has been most recently set indicates “0.9” and the setting ratio d2/d1 is set to “1.2”, when the stereoscopic view ratio d2/d1 is changed up to the setting ratio d2/d1 in two seconds (120 frames), the change value of the stereoscopic view ratio d2/d1 for step S412 in each process loop is 0.0025(=(1.2−0.9)1120). Further, instead of the stereoscopic view ratio d2/d1 being changed at a constant change value in this manner, the stereoscopic view ratio d2/d1 may be changed at a constant change value corresponding to some percentage of difference between the stereoscopic view ratio d2/d1 and the setting ratio d2/d1.

On the other hand, when the object distance d1 is stored as a portion of the setting rate data 330 in the data storage area 323, the object distance d1 which is represented as the most recent object distance by the rate data 328 is equal to the object distance d1 represented by the setting rate data 330. Therefore, it is determined that both of the object distance d1 and the stereoscopic view reference distance d2 cannot be changed (only the stereoscopic view reference distance d2 can be changed). Namely, when the process is advanced to step S411 after the process steps of step S408 and step S409 are performed, it is determined that both of the object distance d1 and the stereoscopic view reference distance d2 cannot be changed. When the CPU 311 determines that both of the object distance d1 and the stereoscopic view reference distance d2 cannot be changed (step S411:NO), the CPU 311 changes the stereoscopic view reference distance d2 such that the stereoscopic view ratio d2/d1 which is represented as the most recent stereoscopic view ratio by the rate data 328 approaches the setting ratio d2/d1 represented by the setting rate data 330 (step S413).

In a state where the player object 50 rapidly accelerates or rapidly decelerates, when the stereoscopic view ratio d2/d1 is gradually changed to the setting ratio d2/d1, a stereoscopically viewable image which does not properly represent change in state of the virtual three-dimensional space may be displayed on the upper LCD 22. Namely, a player may not be effectively notified of the change in the state of the player object 50 (rapid change of the moving speed). Therefore, in the process step of step S413 described above, a change value of the stereoscopic view ratio d2/d1 at which the stereoscopic view ratio d2/d1 changes in step S413 in each process loop is increased as compared to a case where the process step of step S412 is performed, such that the stereoscopic view ratio d2/d1 rapidly changes to the setting ratio d2/d1.

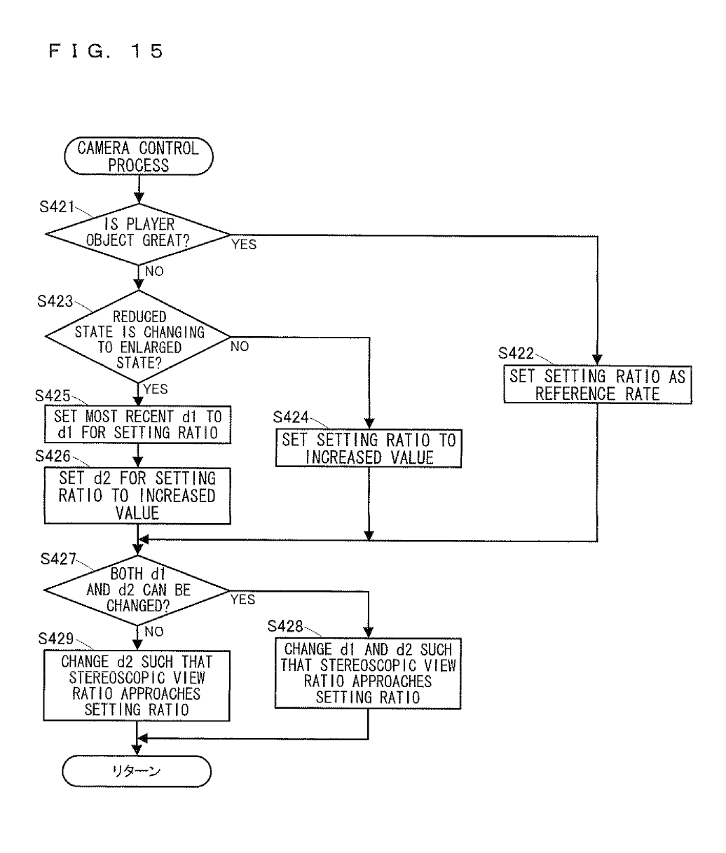

FIG. 14 is a diagram schematically illustrating the virtual three-dimensional space which is obtained when the stereoscopic view reference distance d2 is set as an increased value in a state where the object distance d1 is maintained as it is. For example, when the player object 50 is running at a normal speed by the button 14B (acceleration button) being pressed, the setting ratio d2/d1 is set as the reference rate as illustrated in FIG. 8. When in this state the player object 50 rapidly accelerates due to, for example, the button 14E (rapid acceleration button) being pressed, control of increasing the stereoscopic view reference distance d2 is immediately performed while maintaining the object distance d1 as it is in a series of process steps of step S408, step S409, and step S413 (see FIG. 8 and FIG. 14). In this case, as is apparent from FIG. 14, the reference plane located in front of the player object 50 as viewed from the virtual stereo camera 53 is moved in the far side from the player object 50 as compared to a case where the player object 50 moves at a normal speed (see FIG. 8). Therefore, the player object 50 appears to greatly project toward a player as compared to a case where the player object 50 is moving at a normal speed. Thus, a player can be effectively notified of the great change of the state of the player object 50. In this case, a position of the focus of the player is deviated, and the player object 50 may be momentarily blurred when viewed. In a case where the player object 50 rapidly accelerates (or rapidly decelerates) (see FIG. 14), the setting ratio d2/d1 is increased as compared to a case where the moving speed of the player object 50 is high (see FIG. 10). Therefore, when the player object 50 running at a normal speed rapidly accelerates, a player may be notified of change in state of the player object 50 with enhanced effectiveness as compared to a case where the moving speed of the player object 50 moving at a normal speed is increased without rapidly accelerating the player object 50.

As is apparent from FIG. 13, while the player object 50 is rapidly accelerating or rapidly decelerating, the process is advanced not to step S403 but to step S408, and a state in which only the stereoscopic view reference distance d2 is increased while the object distance d1 is maintained as it is, is continued for a predetermined time period. Thus, when the setting ratio d2/d1 is changed such that only the stereoscopic view reference distance d2 is changed without changing the object distance d1, change of the state of the player object 50 (in the present embodiment, the player object 50 rapidly accelerates or rapidly decelerates) can be effectively represented so as to prevent a player from losing the player object 50.

Further, after completion of rapid acceleration or rapid deceleration, the process is advanced not to step S408 but to step S403. Thus, the setting ratio d2/d1 is controlled so as to be temporarily changed to a value which is different from a value based on the determination result of step S403 and the subsequent steps (see FIG. 14), and thereafter changed to a value based on the determination result of step S403 and the subsequent steps. Specifically, when the player object 50 moving at a normal speed rapidly accelerates, and then shifts to a state in which the player object 50 moves at a high speed, the setting ratio d2/d1 is firstly set such that the stereoscopic view reference distance d2 is set to an increased value while maintaining the object distance d1 as it is, in the process steps of step S408, step S409, and step S413, and while the moving speed of the player object 50 is reduced from the maximum speed to the normal speed, the setting ratio d2/d1 gradually approaches the increased value set in step S407 so as to reduce the object distance d1, to converge with the increased value (see FIG. 14 and FIG. 10).

As described above, the setting ratio d2/d1 is set such that the stereoscopic view reference distance d2 is increased so as to protrude the player object 50 toward a player, and the virtual stereo camera 53 gradually approaches the player object 50 (so as to gradually reduce the object distance d1), thereby naturally representing a state change from a state where the player object 50 rapidly accelerates to a state where the player object 50 moves at a constant high speed (normal speed).

### Second Embodiment

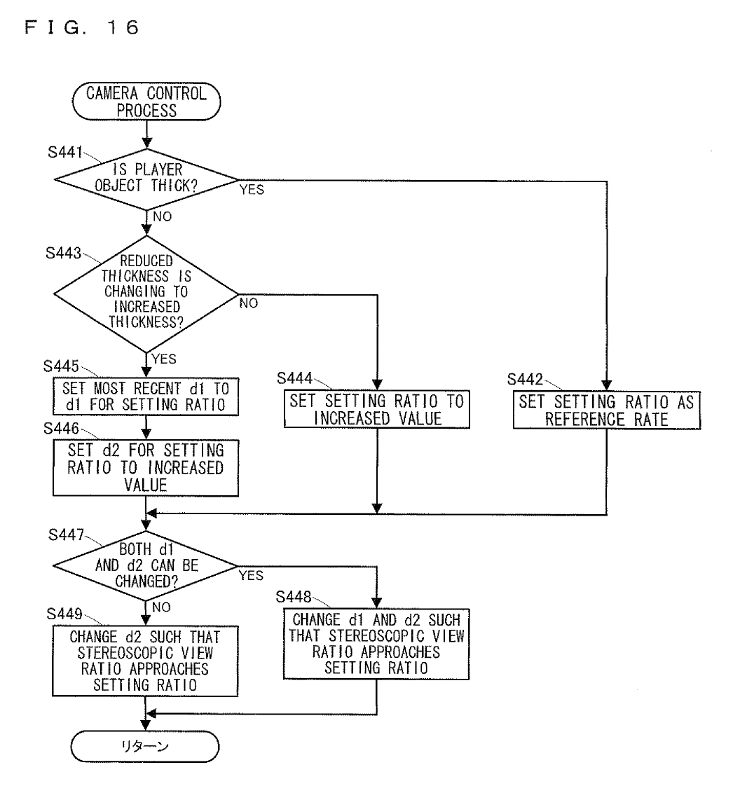

Hereinafter, a second embodiment of the present invention will be described with reference to FIG. 15. In the second embodiment, a camera control process performed by the information processing section 31 when the size of the player object 50 is changed will be described. FIG. 15 is a flow chart showing in detail the camera control process of step S4 shown in FIG. 12, and illustrates the camera control process performed when the size of the player object 50 is changed. In the camera control process described below, description of a part of contents common to the camera control process as described with reference to FIG. 13 is not given.

### Description of Camera Control Process

Following step S3, the CPU 311 determines whether the player object 50 is great (step S421). Specifically, the CPU 311 determines the size of the player object 50 with reference to the size data 3254. As described above, in the present embodiment, when the player object 50 is hit by lightning, the size of the player object 50 is reduced (see FIG. 6), and the size is restored to an original size when a predetermined time period elapses after the player object 50 is hit by the lightning (see FIG. 4).

When the CPU 311 determines that the player object 50 is great (step S421:YES), the CPU 311 sets the setting ratio d2/d1 to the reference rate (step S422), as in step S405. In the present embodiment, the reference rate may be different from the setting rate which is set in step S405, and may be any appropriate value which allows a player to naturally feel that the player object 50 is great.

A stereoscopically viewable image can be displayed on the upper LCD 22 so as to allow a player to panoramically view the player object 50 from a position which is slightly distant from the player object 50 by the process step of step S422 being performed. In order to effectively represent a state in which the player object 50 is enlarged, and the moving range of the player object 50 is increased, the reference rate is set so as to be smaller than the setting ratio d2/d1 which is set in step S424 described below.

When the CPU 311 determines that the player object 50 is not great (step S421:NO), the CPU 311 determines whether the player object 50 is shifting from a reduced state to an enlarged state (step S423). Until a first time period (for example, 8.5 seconds) elapses after the player object 50 is hit by lightning, the player object 50 is in the reduced state. Before a second time period (for example, 1.5 seconds) elapses after elapse of the first time period, the player object 50 is gradually enlarged, and when the second time period elapse, the player object 50 enters completely increased state. The CPU 311 determines whether the player object 50 is shifting from the reduced state to the enlarged state, based on whether the second time period has elapsed after elapse of the first time period.

When the CPU 311 determines that the player object 50 is not shifting from the reduced state to the enlarged state (step S423:NO), namely, when the player object 50 remains small, the CPU 311 sets the setting ratio d2/d1 as an increased value (step S424), as in step S407. Thus, when the CPU 311 sets the setting ratio d2/d1 as an increased value, the virtual stereo camera 53 approaches the player object 50 to reduce the object distance d1, and the reference plane is distanced from the virtual stereo camera 53 to increase the stereoscopic view reference distance d2.

Consequently, a player is allowed to view the stereoscopically viewable image displayed on the upper LCD 22 as if the player is immediately behind the player object 50. The setting ratio d2/d1 is set as an increased value which is greater than a value of the reference rate in order to naturally represent, with reality, a state in which the player object 50 is reduced and surrounding objects seem great.

As described above, the CPU 311 determines whether the player object 50 is enlarged, and changes the setting ratio d2/d1 to a value based on the determination result so as to maintain the stereoscopic view ratio d2/d1 as a predetermined value. Thus, appropriate effect for representing reality according to the size of the player object 50 can be naturally realized.

On the other hand, when the CPU 311 deter lines that the player object 50 is shifting from the reduced state to the enlarged state (step S423:YES), the CPU 311 sets the object distance d1 having been most recently set, to the object distance d1 for the setting ratio (step S425), and sets the stereoscopic view reference distance d2 for the setting ratio, to an increased value (step S426), as in step S408 and step S409 described above.

In this case, when the CPU 311 changes the setting ratio d2/d1, the CPU 311 changes (increases) only the stereoscopic view reference distance d2 while maintaining the object distance d1 as it is before a predetermined time period (the second time period described above) elapses since the start of the state change from the reduced state of the player object 50 to the enlarged state of the player object 50.

Thus, since the stereoscopic view ratio d2/d1 is changed while the object distance d1 is maintained as it is, state in which the player object 50 is shifting from the reduced state to the enlarged state can be naturally represented with reality so as to prevent a player from losing the player object 50.

When the CPU 311 performs the process step of step S422, step S424, or step 5426, the CPU 311 determines whether both of the object distance d1 and the stereoscopic view reference distance d2 can be changed (step S427), as in step S411.

When the CPU 311 determines that both of the object distance d1 and the stereoscopic view reference distance d2 can be changed (step S427:YES), the CPU 311 changes the object distance d1 and the stereoscopic view reference distance d2, based on the player object data 325, such that the stereoscopic view ratio d2/d1 which is represented as the most recent stereoscopic view ratio by the rate data 328 approaches the setting ratio d2/d1 represented by the setting rate data 330 (step S428), as in step S412. The process step of step S428 is performed when the process steps of step S425 and step S426 are not performed, namely when the process step of step S422 or the process step of step S424 is performed.

When the CPU 311 determines that both of the object distance d1 and the stereoscopic view reference distance d2 cannot be changed (step S427:NO), the CPU 311 changes the stereoscopic view reference distance d2 such that the stereoscopic view ratio d2/d1 which is represented as the most recent stereoscopic view ratio by the rate data 328 approaches the setting ratio d2/d1 represented by the setting rate data 330 (step S429), as in step S413.

As is apparent from FIG. 15, while the player object 50 is shifting from the reduced state to the enlarged state, the process is advanced to step S425 and step S426. When the player object 50 has been completely enlarged, the process is advanced to step S422. Therefore, when the player object 50 shifts from the reduced state to the enlarged state, the stereoscopic view ratio d2/d1 is firstly changed to a value which is different from the setting ratio (the reference rate) for the player abject 50 in the enlarged state and the setting ratio (an increased value which is greater than a value of the reference rate) for the player object 50 in the reduced state, in step S425 and step S426. The stereoscopic view ratio d2/d1 is then changed to the reference rate which is set in step S422. When the stereoscopic view ratio d2/d1 is thus changed, a player is allowed to effectively recognize that the size of the player object 50 is changed, and state in which the size of the player object 50 has been changed can be naturally represented with reality.

### Third Embodiment

Hereinafter, a third embodiment of the present invention will be described with reference to FIG. 16. In the third embodiment, a camera control process performed by the information processing section 31 when the thickness of the player object 50 is changed will be described. FIG. 16 is a flow chart showing in detail the camera control process of step S4 shown in FIG. 12, and illustrates the camera control process performed when the thickness of the player object 50 is changed. In the camera control process described below, description of a part of contents common to the camera control process described with reference to FIG. 13 is not given.

### Description of Camera Control Process

Following step S3, the CPU 311 determines whether the thickness of the player object 50 is great or small (step S441). Specifically, the CPU 311 determines whether the thickness of the player object 50 is great or small, with reference to the thickness data 3255. As described above, in the present embodiment, when the player object 50 is compressed by a weight, the thickness of the player object 50 is reduced (see FIG. 7), and the thickness of the player object 50 is restored to an original thickness when a predetermined time period elapses after the player object 50 is compressed (see FIG. 4).

When the CPU 311 determines that the thickness of the player object 50 is great (step S441:YES), the CPU 311 sets the setting ratio d2/d1 as the reference rate (step S442), as in step S405. In this case, the reference rate may be different from the setting ratio which is set in step S405, and may be any appropriate value which allows a player to naturally feel that the thickness of the player object 50 is great.

A stereoscopically viewable image can be displayed on the upper LCD 22 so as to allow a player to panoramically view the player object 50 from a position which is slightly distant from the player object 50 by the process step of step S442 being performed. In order to effectively represent a state in which the thickness of the player object 50 is increased, and the player object 50 can normally move, the reference rate is set so as to be smaller than the setting ratio d2/d1 which is set in step S444 described below.

When the CPU 311 determines that the thickness of the player object 50 is not great (step S441:NO), the CPU 311 determines whether the player object 50 is shifting from the thickness-reduced state to the thickness-increased state (step S443). Until a third time period (for example, four seconds) elapses after the player object 50 is compressed by a weight, the player object 50 is in the thickness-reduced state. Before a fourth time period (for example, 1.5 seconds) elapses after elapse of the third time period, the thickness of the player object 50 is gradually increased, and when the fourth time period elapses, the thickness of the player object 50 becomes completely increased. The CPU 311 determines whether the player object 50 is shifting from the thickness-reduced state to the thickness-increased state, based on whether the fourth time period has elapsed after elapse of the third time period.

When the CPU 311 determines that the player object 50 is not shifting from the thickness-reduced state to the thickness-increased state (step S443:NO), namely, that the player object 50 remains thin, the CPU 311 sets the setting ratio d2/d1 as an increased value (step S444), as in step S407. Thus, when the CPU 311 sets the setting ratio d2/d1 as an increased value, the virtual stereo camera 53 approaches the player object 50 to reduce the object distance d1, and the reference plane is distanced from the virtual stereo camera 53 to increase the stereoscopic view reference distance d2.

Consequently, a player is allowed to view the stereoscopically viewable image displayed on the upper LCD 22 as if the player is immediately behind the player object 50. The setting ratio d2/d1 is set as an increased value which is greater than a value of the reference rate in order to naturally represent, with reality, a state in which the thickness of the player object 50 is reduced.

As described above, the CPU 311 determines whether the thickness of the player object 50 is increased, and changes the setting ratio d2/d1 to a value based on the determination result so as to maintain the stereoscopic view ratio d2/d1 as a predetermined value. Thus, appropriate effect for representing reality according to the thickness of the player object 50 can be naturally realized.

On the other hand, when the CPU 311 determines that the player object 50 is shifting from the thickness-reduced state to the thickness-increased state (step S443:YES), the CPU 311 sets the object distance d1 having been most recently set, to the object distance d1 for the setting ratio (step S445), and sets the stereoscopic view reference distance d2 for the setting ratio, to an increased value (step S446), as in step S408 and step S409 described above.

In this case, when the CPU 311 changes the setting ratio d2/d1, the CPU 311 changes (increase) only the stereoscopic view reference distance d2 while maintaining the object distance d1 as it is until a predetermined time period (the fourth time period described above) elapses since the start of the shifting of the player object 50 from the thickness-reduced state to the thickness-increased state.

Thus, since the stereoscopic view ratio d2/d1 is changed while the object distance d1 is maintained as it is, state in which the player object 50 is shifting from the thickness-reduced state to the thickness-increased state can be naturally represented with reality so as to prevent a player from losing the player object 50.

When the CPU 311 performs the process step of step S442, step S444, or step S446, the CPU 311 determines whether both of the object distance d1 and the stereoscopic view reference distance d2 can be changed (step S447), as in step S411.

When the CPU 311 determines that both of the object distance d1 and the stereoscopic view reference distance d2 can be changed (step S447:YES), the CPU 311 changes the object distance d1 and the stereoscopic view reference distance d2, based on the player object data 325, such that the stereoscopic view ratio d2/d1 which is represented as the most recent stereoscopic view ratio by the rate data 328 approaches the setting ratio d2/d1 represented by the setting rate data 330 (step S448), as in step S412. The process step of step S448 is performed when the process steps of step S445 and step S446 are not performed, namely, when the process step of step S442 or step S444 is performed.

When the CPU 311 determines that both of the object distance d1 and the stereoscopic view reference distance d2 cannot be changed (step S447:NO), the CPU 311 changes the stereoscopic view reference distance d2 such that the stereoscopic view ratio d2/d1 which is represented as the most recent stereoscopic view ratio by the rate data 328 approaches the setting ratio d2/d1 represented by the setting rate data 330 (step S449), as in step S413.

As is apparent from FIG. 16, while the player object 50 is shifting from the thickness-reduced state to the thickness-increased state, the process is advanced to step S445 and step S446. When the thickness of the player object 50 has been completely increased, the process is advanced to step S442. Therefore, when the player object 50 shifts from the thickness-reduced state to the thickness-increased state, the stereoscopic view ratio d2/d1 is firstly changed to a value which is different from the setting ratio (the reference rate) for the player object 50 in the thickness-increased state, and the setting ratio (increased value which is greater than a value of the reference rate) for the player object 50 in the thickness-reduced state, in step S445 and step S446. The stereoscopic view ratio d2/d1 is then changed to the reference rate which is set in step S442. When the stereoscopic view ratio d2/d1 is thus changed, a player is allowed to effectively recognize that the thickness of the player object 50 is changed, and state in which the thickness of the player object 50 has been changed can be naturally represented with reality.

### Function and Effect of the First to the Third Embodiments

As described above, according to the first to the third embodiments, the camera parameters are set based on the stereoscopic view ratio d2/d1 which is a ratio of the stereoscopic view reference distance d2 to the object distance d1. Namely, the camera parameters are set based on a ratio between two distances representing state in the virtual three-dimensional space, instead of data which is inputted from the outside. Therefore, appropriate effect for representing reality according to the state of the player object 50 in the virtual three-dimensional space can be naturally realized.

Further, in the first to the third embodiments, when object parameters of the player object 50 are not changed, the stereoscopic view ratio d2/d1 is maintained as a constant value, so that deterioration of effect representing reality according to the state of the player object 50 can be effectively prevented.

Moreover, in the first to the third embodiments, when change of the object parameters causes change of the state of the player object 50, the stereoscopic view ratio d2/d1 is changed from a value for the state having not been changed, to converge with another value according to the change of the state. Thus, when the state of the player object 50 is changed, the stereoscopic view ratio d2/d1 is exceptionally changed. Therefore, a player can be effectively notified of the change of state of the player object 50, and the stereoscopic effect for the player object 50 can be represented based on the player object 50 the state of which has been changed.

In addition, in the first to the third embodiments, when the stereoscopic view ratio d2/d1 is changed, only the stereoscopic view reference distance d2 is changed while the object distance d1 is temporarily maintained as it is. Therefore, a player that is viewing the stereoscopically viewable image can be effectively notified of the change of the state of the player object 50 which is caused by change of the object parameters, so as to prevent the player from losing the player object 50.

Further, in the first to the third embodiments, the change of the stereoscopic view ratio d2/d1 visually emphasizes that the object parameters have been changed. Therefore, a player can be more effectively notified of the change of the state of the player object 50 due to change of the object parameters.

Furthermore, in the first to the third embodiments, the stereoscopic view ratio d2/d1 gradually changes according to the change of the state of the player object 50. Therefore, the change of the state of the player object 50 can be more naturally represented.

Further, in the first to the third embodiments, when the state of the player object 50 which is a subject object to be operated is changed, the stereoscopic view ratio d2/d1 is controlled. Therefore, the change of the state of the player object 50 which is caused by an operation of a player can be effectively represented.

### Modification

The present invention is not limited to the embodiments described above. The present invention may be implemented in, for example, the following manners.

Specifically, in the embodiments described above, when the change of the state of the player object 50 is started, only the stereoscopic view reference distance d2 is changed while the object distance d1 is maintained as it is, to change the stereoscopic view ratio d2/d1. Instead thereof, when the change of the state of the player object 50 is started, both the object distance d1 and the stereoscopic view reference distance d2 may be changed, to change the stereoscopic view ratio d2/d1.

Further, in the embodiments described above, the stereoscopic view ratio d2/d1 converges with one of an increased value of the setting ratio d2/d1 or a reduced value of the setting ratio d2/d1. However, the values of the setting ratio d2/d1 with which the stereoscopic view ratio d2/d1 converges are not limited to these two values. Specifically, the stereoscopic view ratio d2/d1 may converge with one of three or more values of the setting ratio d2/d1 according to the state (object parameters) of the player object 50.

In addition, in the embodiments described above, a case is described in which a predetermined object of the present invention is the player object 50 operated by a player. However, the predetermined object may be a non-player object. Namely, the present invention is also applicable to, for example, a demonstration screen which is displayed, regardless of an operation of a user (or a player), so as to represent a stereoscopically viewable image of the virtual three-dimensional space.

Further, in the embodiments described above, a series of process steps as described above is realized by using one game apparatus 10. The present invention is not limited thereto. The series of process steps as described above may be realized by a plurality of information processing apparatuses cooperating with each other. Specifically, the function of at least one of the object distance change means, camera parameter setting means, image generation means, and display control means may be realized by, for example, a server device on the network, different than the game apparatus 10. In this case, a game system including the game apparatus 10 and the server device function in the same manner as the game apparatus 10 as described above.

Moreover, in the embodiments described above, the shape of the game apparatus 10, the shapes and mounting positions of various buttons of the operation button 14 and the touch panel 13 of the game apparatus 10, the number of the buttons of the operation button 14, the number of the touch panels 13, and the like are only exemplary ones. Needless to say, the present invention may be realized by using other shapes, numbers, and mounting positions. Further, the order in which the process steps are performed, setting values, the threshold values used for the determinations, and the like, which are described above with reference to the flow charts, are only exemplary ones. Needless to say, the present invention can be realized by using other order and values if the use of the order and values do not cause departure from the scope of the present invention.

In addition, the display control program executed by the game apparatus 10 according to the embodiments described above may be supplied to the game apparatus 10 via a wired or wireless communication line as well as via a storage medium such as the external memory 44. Further, the display control program described above may be previously stored in a non-volatile storage device (the internal data storage memory 35 or the like) in the game apparatus 10. The information storage medium for storing the display control program may be, for example, a CD-ROM, a DVD, an optical disc-type storage medium similar to a CD-ROM or DVD, a flexible disk, a hard disk, a magneto-optical disk, and a magnetic tape, as well as a non-volatile memory. The information storage medium for storing the display control program may be a volatile memory for temporarily storing the display control program.

The present invention is applicable to, for example, a computer-readable storage medium having stored therein a display control program executed by a computer of a display control apparatus for performing a stereoscopically viewable display, a display control apparatus, a display control system, and a display control method.

While the invention has been described in detail, the foregoing description is in all aspects illustrative and not restrictive. It will be understood that numerous other modifications and variations can be devised without departing from the scope of the invention.

What is claimed is:

1. A computer-readable storage medium having stored therein a display control program executed by a computer of a display control apparatus for taking, by using a virtual stereo camera, an image of a virtual three-dimensional space in which a predetermined object is positioned, and for causing a display device to perform a stereoscopically viewable display of the image of the virtual three-dimensional space, the computer of the display control apparatus being caused to function as:
stereoscopic view ratio setting means for setting a stereoscopic view ratio which is a ratio of a stereoscopic view reference distance to an object distance, wherein the object distance represents a distance from a point of view position of the virtual stereo camera to the predetermined object, and the stereoscopic view reference distance represents a distance from the point of view position of the virtual stereo camera to a reference plane corresponding to a position at which a parallax is not generated when the image of the virtual three-dimensional space is taken by the virtual stereo camera;
camera parameter setting means for setting, based on the stereoscopic view ratio, a camera parameter which is a parameter associated with the virtual stereo camera;
image generation means for generating, based on the camera parameter set by the camera parameter setting means, a stereoscopically viewable image which represents the virtual three-dimensional space the image of which is taken by the virtual stereo camera; and
display control means for causing the display device to display the stereoscopically viewable image generated by the image generation means.

2. The computer-readable storage medium having stored therein the display control program according to claim 1, wherein
the display control program causes the computer to further function as object distance change means for changing the object distance, and
the stereoscopic view ratio setting means sets the stereoscopic view ratio based on the object distance changed by the object distance change means.

3. The computer-readable storage medium having stored therein the display control program according to claim 1, wherein
the stereoscopic view ratio setting means sets the stereoscopic view ratio according to an object parameter which is a parameter associated with the predetermined object, and
the camera parameter setting means sets the camera parameter in a state where the stereoscopic view ratio is fixed.

4. The computer-readable storage medium having stored therein the display control program according to claim 3, wherein
the camera parameter setting means includes
determination means for determining whether a state of the predetermined object is subjected to a predetermined change according to change of the object parameter, and
ratio change means for changing the stereoscopic view ratio when the determination means determines that the state of the predetermined object is subjected to the predetermined change.

5. The computer-readable storage medium having stored therein the display control program according to claim 4, wherein the ratio change means changes the stereoscopic view ratio so as to indicate a value based on the object parameter having been changed.

6. The computer-readable storage medium having stored therein the display control program according to claim 5, wherein
the object parameter is a parameter indicating a moving speed of the predetermined object,
the determination means determines whether the moving speed of the predetermined object is outside a predetermined threshold value, and
the ratio change means changes the stereoscopic view ratio so as to indicate a value based on the moving speed of the predetermined object when the determination means determines that the moving speed of the predetermined object is outside the predetermined threshold value.

7. The computer-readable storage medium having stored therein the display control program according to claim 6, wherein the ratio change means changes the stereoscopic view ratio so as to indicate a value which is greater than a predetermined reference rate when the moving speed of the predetermined object is greater than the predetermined threshold value.

8. The computer-readable storage medium having stored therein the display control program according to claim 6, wherein the ratio change means changes the stereoscopic view ratio so as to indicate a value which is less than a predetermined reference rate when the moving speed of the predetermined object is less than the predetermined threshold value.

9. The computer-readable storage medium having stored therein the display control program according to claim 5, wherein
the object parameter is a parameter indicating an acceleration of the predetermined object,
the determination means determines whether the acceleration of the predetermined object is outside a predetermined threshold value, and
the ratio change means changes the stereoscopic view ratio so as to indicate a value based on the acceleration of the predetermined object when the determination means determines that the acceleration of the predetermined object is outside the predetermined threshold value.

10. The computer-readable storage medium having stored therein the display control program according to claim 9, wherein the ratio change means changes the stereoscopic view ratio so as to indicate a value which is greater than a predetermined reference rate when the acceleration of the predetermined object in an imaging direction of the virtual stereo camera is greater than a first threshold value.

11. The computer-readable storage medium having stored therein the display control program according to claim 9, wherein the ratio change means changes the stereoscopic view ratio so as to indicate a value which is greater than a predetermined reference rate when the acceleration of the predetermined object in an imaging direction of the virtual stereo camera is less than a second threshold value.

12. The computer-readable storage medium having stored therein the display control program according to claim 5, wherein
the object parameter is a parameter indicating a size of the predetermined object,
the determination means determines whether the size of the predetermined object is changed, and
the ratio change means changes the stereoscopic view ratio so as to indicate a value based on the size of the predetermined object when the determination means determines that the size of the predetermined object is changed.

13. The computer-readable storage medium having stored therein the display control program according to claim 12, wherein the ratio change means changes the stereoscopic view ratio so as to indicate a value which is greater than a predetermined reference rate when the size of the predetermined object is reduced.

14. The computer-readable storage medium having stored therein the display control program according to claim 5, wherein
the object parameter is a parameter indicating a thickness of the predetermined object,
the determination means determines whether the thickness of the predetermined object is changed, and
the ratio change means changes the stereoscopic view ratio so as to indicate a value based on the thickness of the predetermined object when the determination means determines that the thickness of the predetermined object is changed.

15. The computer-readable storage medium having stored therein the display control program according to claim 14, wherein the ratio change means changes the stereoscopic view ratio so as to indicate a value which is greater than a predetermined reference rate when the thickness of the predetermined object is reduced.

16. The computer-readable storage medium having stored therein the display control program according to claim 4, wherein the ratio change means temporarily maintains the object distance as it is when the stereoscopic view ratio is changed.

17. The computer-readable storage medium having stored therein the display control program according to claim 5, wherein the ratio change means changes the stereoscopic view ratio so as to indicate a value which is different from a value based on the object parameter, and thereafter changes the stereoscopic view ratio so as to indicate the value based on the object parameter, when the stereoscopic view ratio is changed.

18. The computer-readable storage medium having stored therein the display control program according to claim 4, wherein the ratio change means gradually changes the stereoscopic view ratio.

19. The computer-readable storage medium having stored therein the display control program according to claim 1, wherein
the virtual stereo camera includes a left eye camera for taking an image for a left eye and a right eye camera for taking an image for a right eye, and
the point of view position of the virtual stereo camera is any position between the left eye camera and the right eye camera.

20. The computer-readable storage medium having stored therein the display control program according to claim 19, wherein the point of view position of the virtual stereo camera is a position of the middle point of a line segment connecting between the left eye camera and the right eye camera.

21. The computer-readable storage medium having stored therein the display control program according to claim 19, wherein the point of view position of the virtual stereo camera is one of a position of the left eye camera and a position of the right eye camera.

22. The computer-readable storage medium having stored therein the display control program according to claim 3, wherein
the display control program causes the computer to further function as input reception means for receiving an input from input means operated by a user, and
the object parameter changes according to the input received by the input reception means.

23. A display control apparatus for taking, by using a virtual stereo camera, an image of a virtual three-dimensional space in which a predetermined object is positioned, and for causing a display device to perform a stereoscopically viewable display of the image of the virtual three-dimensional space, the display control apparatus comprising:
stereoscopic view ratio setting means for setting a stereoscopic view ratio which is a ratio of a stereoscopic view reference distance to an object distance, wherein the object distance represents a distance from a point of view position of the virtual stereo camera to the predetermined object, and the stereoscopic view reference distance represents a distance from the point of view position of the virtual stereo camera to a reference plane corresponding to a position at which a parallax is not generated when the image of the virtual three-dimensional space is taken by the virtual stereo camera;
camera parameter setting means for setting, based on the stereoscopic view ratio, a camera parameter which is a parameter associated with the virtual stereo camera;
image generation means for generating, based on the camera parameter set by the camera parameter setting means, a stereoscopically viewable image which represents the virtual three-dimensional space the image of which is taken by the virtual stereo camera; and
display control means for causing the display device to display the stereoscopically viewable image generated by the image generation means.

24. A display control system for taking, by using a virtual stereo camera, an image of a virtual three-dimensional space in which a predetermined object is positioned, and for causing a display device to perform a stereoscopically viewable display of the image of the virtual three-dimensional space, the display control system comprising:
stereoscopic view ratio setting means for setting a stereoscopic view ratio which is a ratio of a stereoscopic view reference distance to an object distance, wherein the object distance represents a distance from a point of view position of the virtual stereo camera to the predetermined object, and the stereoscopic view reference distance represents a distance from the point of view position of the virtual stereo camera to a reference plane corresponding to a position at which a parallax is not generated when the image of the virtual three-dimensional space is taken by the virtual stereo camera;
camera parameter setting means for setting, based on the stereoscopic view ratio, a camera parameter which is a parameter associated with the virtual stereo camera;
image generation means for generating, based on the camera parameter set by the camera parameter setting means, a stereoscopically viewable image which represents the virtual three-dimensional space the image of which is taken by the virtual stereo camera; and
display control means for causing the display device to display the stereoscopically viewable image generated by the image generation means.

25. A display control method for taking, by using a virtual stereo camera, an image of a virtual three-dimensional space in which a predetermined object is positioned, and for causing a display device to perform a stereoscopically viewable display of the image of the virtual three-dimensional space, the display control method comprising the steps of:
setting a stereoscopic view ratio which is a ratio of a stereoscopic view reference distance to an object distance, wherein the object distance represents a distance from a point of view position of the virtual stereo camera to the predetermined object, and the stereoscopic view reference distance represents a distance from the point of view position of the virtual stereo camera to a reference plane corresponding to a position at which a parallax is not generated when the image of the virtual three-dimensional space is taken by the virtual stereo camera;
setting, based on the stereoscopic view ratio, a camera parameter which is a parameter associated with the virtual stereo camera;
generating, based on the camera parameter having been set, a stereoscopically viewable image which represents the virtual three-dimensional space the image of which is taken by the virtual stereo camera; and
displaying, by using the display device, the stereoscopically viewable image having been generated.
